(19) United States
(12) Patent Application Publication
(10) Pub. No.: US 2024/0419744 A1
(43) Pub. Date: Dec. 19, 2024

(54) STORAGE SYSTEM AND STORAGE CONTROL METHOD

(71) Applicant: Hitachi, Ltd., Tokyo (JP)

(72) Inventors: Hideyuki KOSEKI, Tokyo (JP); Akira DEGUCHI, Tokyo (JP); Hiroki FUJII, Tokyo (JP)

(73) Assignee: Hitachi, Ltd., Tokyo (JP)

(21) Appl. No.: 18/597,166

(22) Filed: Mar. 6, 2024

(30) Foreign Application Priority Data
Jun. 15, 2023 (JP) 2023-098762

(51) Int. Cl. G06F 16/951

(52) U.S. Cl. CPC G06F 16/951

(57) ABSTRACT

When data is to be stored in or transferred to a storage system including a controller, the controller causes a selected offload instance to compress or to decompress the data to be stored in or to be transferred to the storage system, the selected offload instance being one or more offload instances that support a specific compression scheme and to which a compression or decompression load is to be offloaded.

### BACKGROUND OF THE INVENTION

### 1. Field of the Invention

The present invention generally relates to storage control.

### 2. Description of the Related Art

As an example of data transfer between storages (storage systems), there is compressed remote copying (remote copying of compressed data). For the compressed remote copying, the technology disclosed in JP 2023-13639 A is known. According to JP 2023-13639 A, a first storage compresses data using a compression scheme that is executable by a second storage, and transfers the compressed data to the second storage. In other words, the first and second storages support a common compression scheme.

### SUMMARY OF THE INVENTION

In recent years, there have been increasing cases in which data is copied to a cloud storage (a storage system implemented in a cloud environment (typically, a public cloud environment)). This kind of data copying can be done via compressed remote copying.

However, cloud storages do not always support the compression scheme supported by the source storage of copying (the storage system from which a copy is made).

An example of such data copying includes copying of data from a primary volume that is in an on-premises storage (an example of the source storage of copying) to a secondary volume in a cloud storage. Let us assume herein that the cloud storage supports a compression scheme A, and the on-premises storage supports a compression scheme B having a higher data compression ratio than the compression scheme A, as well as the compression scheme A. It is preferable for the data to be copied from the primary volume in the on-premises storage to be compressed with the compression scheme B. This is because, with the compression scheme B, the total amount of data to be transferred can be reduced, so that reductions in the time required for copying, the network load, and the power consumption can all be achieved. However, even if data compressed with the compression scheme B is copied to the secondary volume, as long as the compression scheme B is not supported by the cloud storage, the cloud storage cannot decompress and provide the compressed data to the secondary volume.

In the manner described above, in order to implement compressed remote copying, the source storage of copying and the target storage of copying both need to support the same compression scheme.

This kind of drawback is not limited to the situation in which the cloud storage is the target storage of copying, but is also relevant in the situation in which the cloud storage is the source storage of copying, for example. This type of drawback is not limited to a situation in which the type of data transfer is remote copying either, and is also pertinent to a situation in which the cloud storage is the storage to which backup data is to be restored, for example.

Furthermore, although remote copying is used as an example in the description of the background and the technical drawback, this kind of drawback may also be relevant to applications other than data transfer such as remote copying. For example, taking an example of data input/output from a host to a storage, there are situations in which it is desirable for the data stored in the storage to be compressed or decompressed using a compression scheme not supported by the storage.

When data is to be stored in or to be transferred to a storage system that includes a controller, the controller causes a selected offload instance to compress or to decompress the data to be stored in or to be transferred to the storage system, the selected offload instance being one or more of offload instances that support a specific compression scheme and to which a compression or decompression load is to be offloaded.

According to the present invention, even if a target compression scheme is not supported by the storage system, the target data to be stored or to be transferred can be compressed or decompressed using the compression scheme. Problems, configurations, and advantageous effects other than those explained above will become clear from the following description of the embodiment.

### BRIEF DESCRIPTION OF THE DRAWINGS

FIG. 1 illustrates a configuration example of the entire system including a data transfer system according to a first embodiment;

FIG. 2 illustrates a configuration example of a primary storage;

FIG. 3 illustrates a configuration example of a secondary storage;

FIG. 4 illustrates a configuration example of an offload instance;

FIG. 5 schematically illustrates an overview of an example of remote copying;

FIG. 6A illustrates a configuration example of a JVOL;

FIG. 6B illustrates a configuration example of a JNCB;

FIG. 7 illustrates an example of a corresponding relationship between a compressed JNL (C-JNL) and a plaintext JNL (P-JNL);

FIG. 8 illustrates a configuration example of a pair management table;

FIG. 9 illustrates a configuration example of an algorithm management table;

FIG. 10 illustrates a configuration example of a VOL management table;

FIG. 11 illustrates a configuration example of an offload instance management table;

FIG. 12 illustrates a configuration example of a support management table;

FIG. 13 illustrates the sequence of main task processing;

FIG. 14 illustrates the sequence of copy preparation processing;

FIG. 15 illustrates the sequence of JNL creation processing;

FIG. 16 illustrates the sequence of JVOL storing processing;

FIG. 17 illustrates the sequence of JNL transfer processing;

FIG. 18 illustrates the sequence of response clearance processing;

FIG. 19 illustrates the sequence of secondary copying processing;

FIG. 20 illustrates the sequence of decompression requesting processing;

FIG. 21 illustrates the sequence of offload resource adjustment processing;

FIG. 22 illustrates a configuration example of an algorithm selection table according to a second embodiment;

FIG. 23 schematically illustrates an overview of an example of remote copying according to a fourth embodiment;

FIG. 24 illustrates a configuration example of catalog information;

FIG. 25 illustrates a configuration example of an object; and

FIG. 26 illustrates a configuration example of an offload instance according to a fifth embodiment.

### DESCRIPTION OF THE PREFERRED EMBODIMENTS

In the description hereunder, an “interface device” include one or more interface devices. The one or more interface devices may include at least one of the following:
One or more input/output (I/O) interface devices. An input/output (I/O) interface device is an interface device with at least one of an I/O device and a remote computer for displaying. The I/O interface device for a computer for displaying may be a communication interface device. At least one I/O device may also be any user interface device, examples of which include an input device such as a keyboard and a pointing device, and an output device such as a display device.
One or more communication interface devices. The one or more communication interface devices may be one or more communication interface devices of the same type (e.g., one or more network interface cards (NIC)) or communication interface devices of two or more different types (e.g., an NIC and a host bus adapter (HBA)).

In the description hereunder, a “memory” is one or more memory devices that are examples of one or more storage devices, and a typical example of the memory is a main storage device. The one or more memory devices in the memory may be a volatile memory device or a nonvolatile memory device.

In the description hereunder, a “persistent storage device” include one or more persistent storage devices that are examples of one or more storage devices. The persistent storage device may typically be a nonvolatile storage device (such as an auxiliary storage device). Specific examples of the persistent storage device include a hard disk drive (HDD), a solid state drive (SSD), a non-volatile memory express (NVME) drive, or a storage class memory (SCM).

In the description hereunder, a “processor” include one or more processor devices. At least one of the processor devices may typically be a microprocessor device such as a central processing unit (CPU), but may also be a processor device of another type, e.g., a graphics processing unit (GPU). At least one of the processor devices may be a single-core processor or a multi-core processor. At least one processor device may be a processor core. At least one of the processor devices may be a processor device in a broad sense, for example, a circuitry that is a collection of gate arrays executing a part or the whole of processing described in a hardware description language (such as a field-programmable gate array (FPGA), a complex programmable logic device (CPLD), or an application specific integrated circuit (ASIC)).

In the description hereunder, a program is sometimes described as an entity that executes some processing. However, because a program is executed by a processor, processing described to be executed by a program as an executing entity may be processing executed by a processor or by a device including a processor (because typically a storage device and/or an interface device is used as appropriate, in the processing performed by a processor executing a program). A program may be installed from a program source. A program source may be a storage medium (such as a non-transitory storage medium) that is readable by a program distribution computer or a computer, for example. Descriptions of programs hereunder are provided for the illustrative purpose only, and a plurality of programs may also be combined into one program, or one program may be divided into a plurality of programs.

In addition, in the description hereunder, data making an output in response to an input will be sometimes described using an expression such as “xxx table”, but the data may be data having any structure (the data may be structured data or unstructured data, for example). Such data may also be a learning model, representative examples of which include a neural network, a genetic algorithm, and a random forest that generate an output in response to an input. Therefore, the “xxx table” can also be referred to as “xxx data”. Configurations of tables described hereunder are provided for the illustrative purpose only, and one table may be divided into two or more tables, or the whole or a part of two or more tables may together form one table.

“VOL” stands for a logical volume, and is a logical storage area to be provided. A VOL may be a real VOL (RVOL) or a virtual VOL (VVOL). A “RVOL” may be a VOL based on a physical storage resource (e.g., one or more PDEVs) in a storage that provides the RVOL. A “VVOL” may be a VOL including a plurality of virtual areas (virtual storage areas) and conforming to some capacity virtualization technology (typically, thin provisioning). The “PDEV” may be a physical storage device (e.g., a persistent storage device).

Furthermore, in the description hereunder, an ID or a number is used as the identification information of an element, but examples of the identification information are not limited thereto.

Furthermore, in the description hereunder, when the same kind of elements are to be described without distinguishing one another, the common part of the reference numerals is sometimes used. When elements of the same kind are to be distinguished from one another, respective reference numerals are sometimes used.

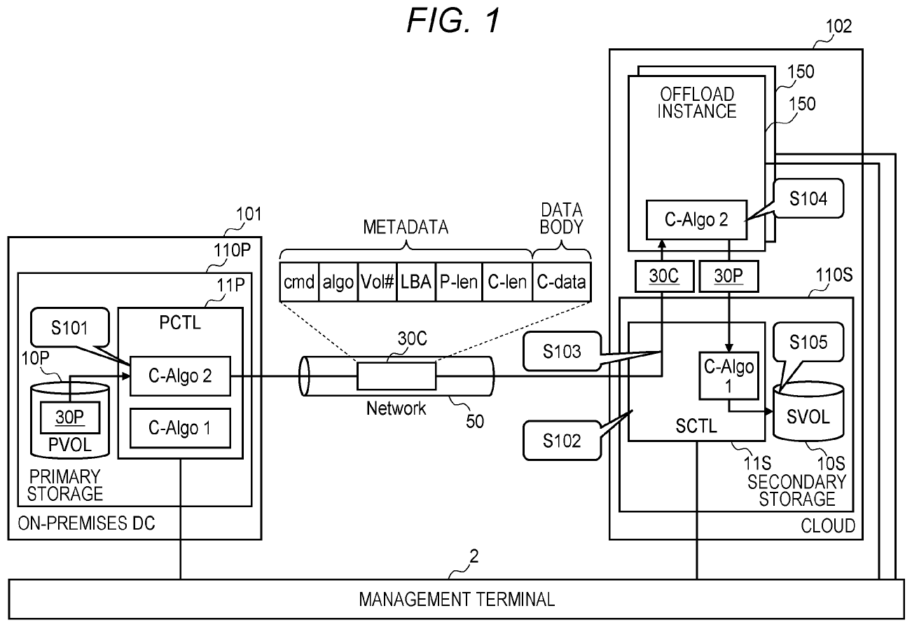

FIG. 1 illustrates a configuration example of the entire system including a data transfer system according to a first embodiment.

The data transfer system according to the present embodiment is a remote copying system, and includes a primary storage 110P and a secondary storage 110S. A cloud 102 includes one or more offload instances 150.

The primary storage 110P is an on-premises storage system deployed in an on-premises data center (DC) 101. The primary storage 110P may be implemented as a cloud storage. The primary storage 110P includes a PCTL 11P and a PVOL 10P. The PCTL 11P is a controller of the primary storage 110P, and includes a memory and a CPU, for example. The PCTL 11P supports a C-Algo1 and a C-Algo2. “C-Algo” stands for compression algorithm (one example of a compression scheme). The C-Algo2 has a higher compression ratio than that of the C-Algo1. The PVOL 10P is the source VOL of a copy.

The secondary storage 110S is in the cloud 102. The cloud 102 is a cloud environment, and is typically a public cloud environment. The secondary storage 110S therefore is a software-defined storage (SDS) in the cloud 102. The secondary storage 110S includes an SCTL 11S and a SVOL 10S. The SCTL 11S serves the function of the controller of the secondary storage 110S, and includes a virtual memory and a virtual CPU, for example. The SCTL 11S supports the C-Algo1. The SVOL 10S is the target VOL of the copy.

The offload instance 150 is a compute service in the cloud 102. In the present embodiment, the offload instance 150 is an instance for executing compression and/or decompression, and supports a C-Algo. The offload instance 150 typically is a function for complementing the function of the secondary storage 110S, and therefore, supports a C-Algo that is not supported by the secondary storage 110S (e.g., C-Algo2).

The PVOL 10P of the primary storage 110P and the SVOL 10S of the secondary storage 110S are in a remote-copying relationship (together form a VOL pair). There is no C-Algo compatibility between the primary storage 110P and the secondary storage 110S. Specifically, the primary storage 110P supports the C-Algo1, but the secondary storage 110S does not support the C-Algo2 (the C-Algo having a higher compression ratio than the C-Algo1), which is supported by the primary storage 110P.

The primary storage 110P compresses a plaintext 30P, as data to be remotely copied from the PVOL 10P, into a compressed text 30C, and the compressed text 30C is transferred to the secondary storage 110S via the communication network 50 (such as the Internet). The compressed text 30C includes metadata and a data body. The data body is compression of plaintext data included in the plaintext 30P. The metadata includes information related to the compressed text 30C, and includes items listed below, for example:
cmd: information indicating remote copying (e.g., initial copying, which will be described later).
algo: the identification information of the C-Algo used for the compression.
Vol#: the VOL number of the SVOL 10S (and/or the PVOL 10P).
LBA: the logical block address (LBA) representing the target area of the copying in the SVOL 10S (and/or the source area of the copying in the PVOL 10P).
P-len: the data length of the plaintext data.
C-len: the data length of the compressed data.

The offload instance 150 illustrated in FIG. 1 may be set via a management terminal 2, for example. The management terminal 2 may be a computer that communicates with the cloud 102 or a management console (e.g., a client) in the on-premises DC 101.

A general sequence of exemplary remote copying according to the present embodiment will be described below.

The management terminal 2 transmits a remote-copying command to the primary storage 110P and/or the secondary storage 110S. Each of the primary storage 110P and the secondary storage 110S receives the remote-copying command from the management terminal 2, via or not via another storage. In response to the remote-copying command, the primary storage 110P and the secondary storage 110S start initial copying (start making an initial copy of the PVOL 10P to the SVOL 10S).

At this time, the PCTL 11P in the primary storage 110P compresses the plaintext 30P in the PVOL 10P, using the C-Algo2 (e.g., the C-Algo having the highest compression ratio), and transfers the compressed text 30C to the secondary storage (S101). Before transferring the compressed text 30C, the primary storage 110P may notify the secondary storage 110S of the start of the initial copying, and the identification information of the C-Algo used. Upon receiving the notification, the secondary storage 110S may activate the offload instance 150 supporting the C-Algo to use.

The SCTL 11S in the secondary storage 110S receives the compressed text 30C, and determines whether the secondary storage 110S is capable of decompressing the compressed data, based on the algo in the metadata of the compressed text 30C (S102). In the example explained herein, the determination result in S102 is false. This is because the C-Algo2 identified from the algo is the C-Algo that is not supported by the secondary storage 110S.

If the determination result in S102 is false, the SCTL 11S transmits a decompression request with the compressed text 30C mapped thereto, to the offload instance 150 supporting the C-Algo 2 identified from the algo (S103). The offload instance 150 having received the decompression request decompresses the compressed data corresponding to the compressed text 30C that is mapped to the decompression request, using the C-Algo 2, and transfers the plaintext 30P to the secondary storage 110S, as the decompressed data (S104).

The SCTL 11S in the secondary storage 110S then compresses the plaintext 30P using the C-Algo1 provided to the SCTL 11S, and stores the compressed data in the SVOL 10S (S105). Note that, in S105, the SCTL 11S may store the plaintext data in the SVOL 10S without compressing the data.

The present embodiment will now be described in detail.

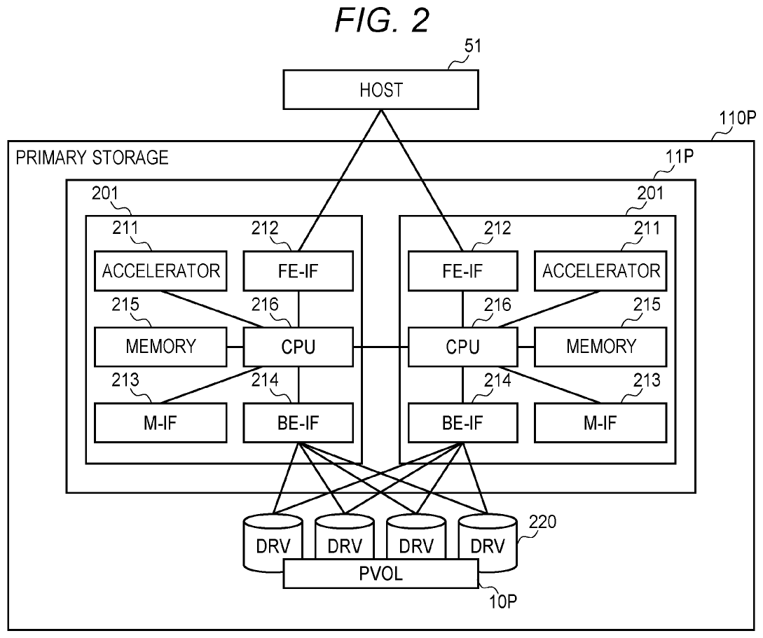

FIG. 2 illustrates a configuration example of the primary storage 110P.

The primary storage 110P includes the PCTL 11P and a plurality of drives 220. These drives 220 are one example of a persistent storage device.

The PCTL 11P includes redundant controllers 201. Each of the controllers 201 includes an FE-IF 212, a BE-IF 214, an M-IF 213, an accelerator 211, a memory 215, and a CPU 216 that is connected to these elements.

The FE-IF 212 is a front-end interface device, and communicates with a host 51. The host 51 may be an example of a transmitter of an I/O request, and may be a physical computer or a logical computer (e.g., a virtual machine). The BE-IF 214 is a back-end interface device, and communicates with each of the drives 220. The M-IF 213 is an interface device that communicates with the management terminal 2. The accelerator 211 is a piece of hardware that executes compression and decompression using the C-Algo. The memory 215 temporarily stores therein data to be stored in the drives 220, and also stores therein a program to be executed by the CPU 216. The CPU 216 performs I/O to a VOL, or runs remote copying to the secondary storage 110S, by executing a program. The accelerator 211 may be omitted, and in such a case, the compression and the decompression may be performed by the CPU 216.

The PCTL 11P manages VOLs such as the PVOL 10P that is based on the plurality of drives 220. For example, the CPU 216 provides the PVOL 10P to the host 51. The CPU 216 receives an input/output (I/O) request designating the PVOL 10P via the FE-IF 212, and performs data I/O to and from the PVOL 10P (the plurality of drives 220 on which the PVOL 10P is based), in accordance with the I/O request. The CPU 216 may cache the I/O data in the memory 215. The CPU 216 also causes, during the initial copying, the accelerator 211 to compress data in the PVOL 10P using some C-Algo, and transfers the compressed text to the secondary storage 110S. During regular copying (update copying), the CPU 216 causes the accelerator 211 to compress write data (data written) to the PVOL 10P using some C-Algo, and transfers the compressed text to the secondary storage 110S.

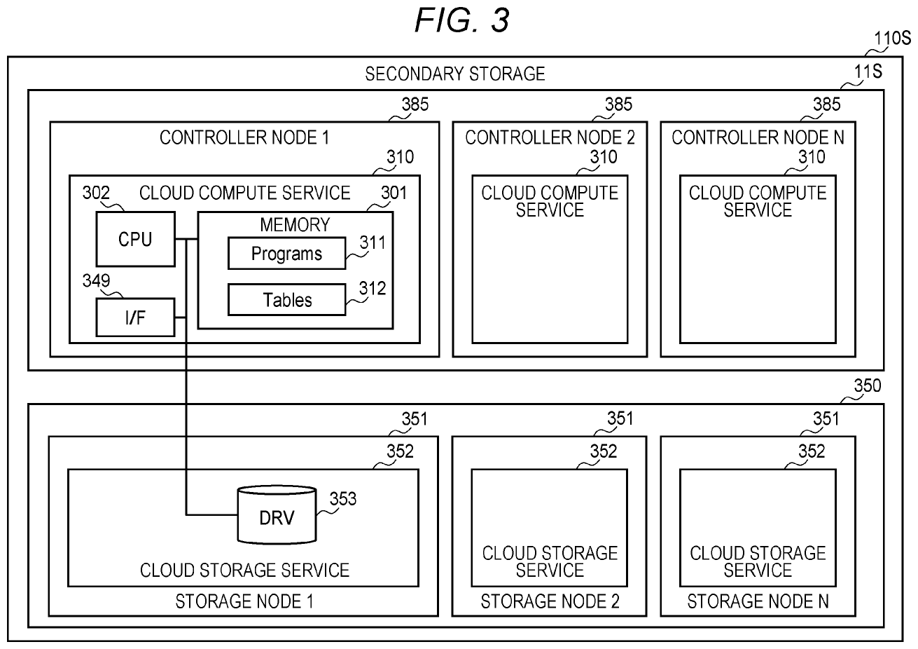

FIG. 3 illustrates a configuration example of the secondary storage 110S.

The secondary storage 110S is a scale-out storage including one or more nodes (typically, logical nodes). The one or more nodes are roughly classified into controller nodes 385 and storage nodes 351.

Each of the storage nodes 351 is a cloud storage service 352 (e.g., a block storage service or an object storage service). The cloud storage service 352 provides a drive 353. The VOL such as the SVOL 10S may be a logical storage area that is based on one or more of the drives 353 provided by one or more cloud storage services 352.

The secondary storage 110S includes one or more controller nodes 385, as the SCTL 11S. Each of the controller nodes 385 is a cloud compute service 310 (instance). The cloud compute service 310 includes an interface 349, a memory 301, and a CPU 302 that is connected to the interface 349 and the memory 301. The interface 349, the memory 301, and the CPU 302 may be logical components that are based on a physical interface device, a memory, and a processor in the cloud 102, respectively.

The interface 349 communicates with elements such as another controller node 385, a storage node 351, and an offload instance 150. The memory 301 includes tables 312 that are one or more tables, and programs 311 that are one or more programs. The programs 311 are executed by the CPU 302. The CPU 302 may receive an I/O request designating the SVOL 10S (or a duplicate VOL thereof) from the host 51 (see FIG. 2) or another host, and perform the data I/O to and from the VOL (VOL based on one or more drives 353 of one or more cloud storage services 352) designated in the I/O request, in accordance with the I/O request. When read data is compressed data, the CPU 302 may decompress the compressed data with the C-Algo supported by the secondary storage 110S (or cause the offload instance 150 to decompress the compressed data), and provide the decompressed data to the host.

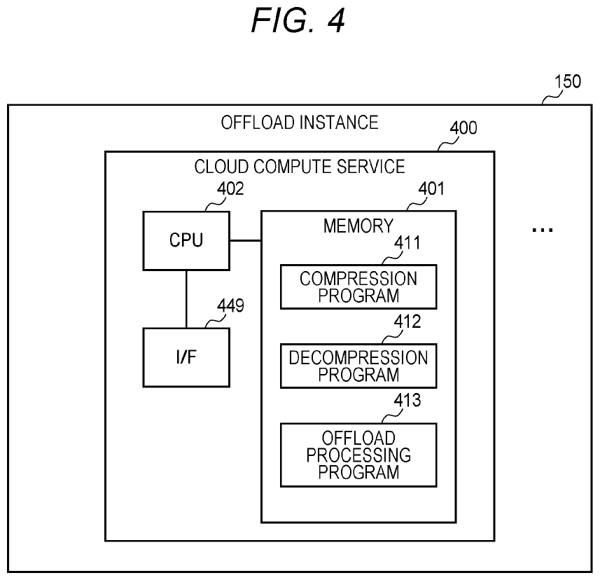

FIG. 4 illustrates a configuration example of the offload instance 150.

The offload instance 150 is one or more cloud compute services 400. The cloud compute service 400 includes an interface 449, a memory 401, and a CPU 402 that is connected to the interface 449 and the memory 401. The interface 449, the memory 401, and the CPU 402 may be logical components that are based on a physical interface device, a memory, and a processor in the cloud 102, respectively.

The interface 449 communicates with elements such as the secondary storage 110S (e.g., the controller node 385). The memory 401 includes an offload processing program 413, and a compression program 411 and a decompression program 412, the latter two being the programs for executing the C-Algo supported thereby. The offload processing program 413 may be an interface program that calls the compression program 411 or the decompression program 412 upon receiving a compression command or a decompression command from the secondary storage 110S. These programs 411 to 413 are executed by the CPU 402.

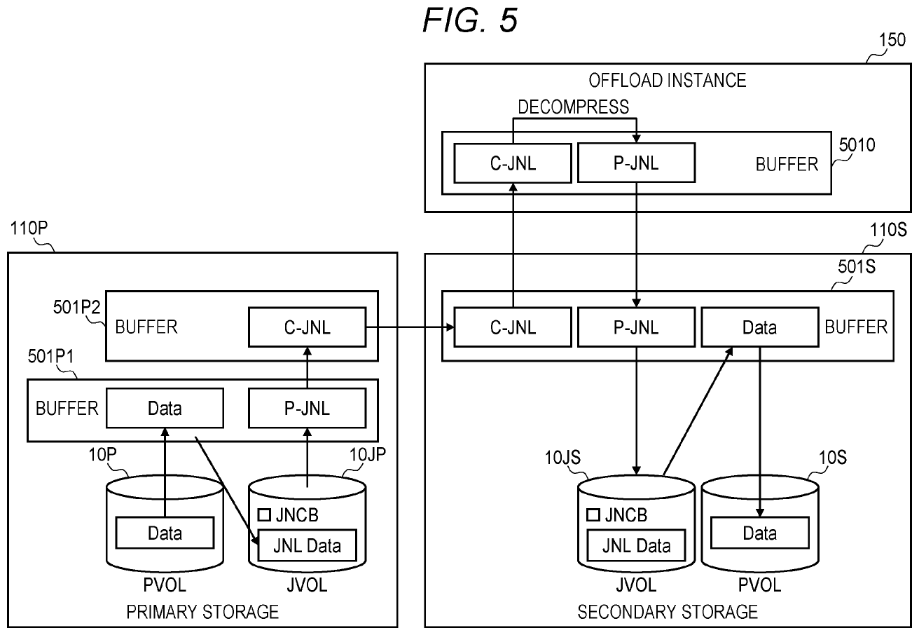

FIG. 5 schematically illustrates an overview of an example of remote copying.

The primary storage 110P includes buffers 501P1 and 501P2, the PVOL 10P, and a JVOL 10JP. Each of the buffers 501P1 and 501P2 is provided in a storage area included in the PCTL 11P (e.g., in the memory 215). The buffer 501P1 stores therein plaintext data and a plaintext JNL (P-JNL). The buffer 501P2 stores therein a compressed JNL (C-JNL). The JVOL 10JP is a VOL in which journals (JNLs) are stored. Note that the P-JNL is an example of the plaintext 30P illustrated in FIG. 1, and the C-JNL is an example of the compressed text 30C illustrated in FIG. 1. The JNL includes N sets of data (where N is an integer equal to or more than one). Each of these data sets includes a journal control block (JNCB) and JNL data. The JNCB is an example of the metadata. The JNL data is an example of the data body.

The secondary storage 110S includes a buffer 501S, the SVOL 10S, and a JVOL 10JS. The buffer 501S is provided in a storage area included in the SCTL 11S (e.g., in the memory 301). The buffer 501S stores therein plaintext data, the P-JNL, and the C-JNL. The JVOL 10JS is a VOL in which the JNLs (JNCB and JNL data) are stored.

The offload instance 150 includes a buffer 5010. The buffer 5010 is provided in a storage area in the offload instance 150 (e.g., the memory 401). The buffer 5010 stores therein the P-JNL and the C-JNL.

In the present embodiment, the remote copying is what is called asynchronous remote copying. Specifically, for example, when data is written to the PVOL 10P in response to a write request from the host 51, the primary storage 110P returns a response of completion for the write request to the host 51, even if such data has not been written (even if the data has not been copied) to the SVOL 10S in the secondary storage 110S. In the remote copying, the data to copied to the SVOL 10S is copied via the JVOL 10JP and the JVOL 10JS. One of the JVOLs 10JP and 10JS may be omitted. Alternatively, an area may be provided on the memory as at least one of the JVOL 10JP and the JVOL 10JS. The JVOL 10JP may be shared among one or more PVOLs 10P, and the JVOL 10JS may be shared among one or more SVOLs 10S.

The PCTL 11P stores data written in the PVOL 10P in the JVOL 10JP as JNL data, and also stores the JNCB that is the metadata of the JNL data in the JVOL 10JP.

In the remote copying, the PCTL 11P reads N sets of data (JNCB and JNL data) from the JVOL 10JP, to create a P-JNL including the N data sets, on the buffer 501P1. The PCTL 11P compresses the data part of the P-JNL data (the JNL data in the N data sets) using some C-Algo, to create a C-JNL on the buffer 501P2. The PCTL 11P then transfers the C-JNL to the secondary storage 110S. In the meta-part (typically N JNCBs) of the C-JNL, the identification information of the C-Algo used is recorded.

Upon receiving the C-JNL, the SCTL 11S in the secondary storage 110S stores the C-JNL in the buffer 501S, identifies the C-Algo from the meta-part of the C-JNL, and determines whether the secondary storage 110S supports the identified C-Algo. If the result of the determination is false, the SCTL 11S transmits a decompression request with the C-JNL mapped thereto (a request for decompressing the data part of the C-JNL), to the offload instance 150 supporting the identified C-Algo. In response to the decompression request, the offload instance 150 stores the C-JNL mapped to the decompression request in the buffer 5010, and decompresses the data part of the C-JNL using the C-Algo supported by the offload instance 150. The offload instance 150 stores the P-JNL including the meta-part of the C-JNL and the decompressed data part in the buffer 5010, and returns the P-JNL to the secondary storage 110S, as a response to the decompression request.

The SCTL 11S in the secondary storage 110S stores the P-JNL received from the offload instance 150 in the buffer 501S. The SCTL 11S stores the N data sets (the JNCB and decompressed JNL data) included the P-JNL, in the JVOL 10JS. The SCTL 11S then stores the JNL data in the SVOL 10S, in accordance with the content of the JNCB. As a result, the remote copying of the data written to the PVOL 10P to the SCTL 11S is completed. Note that the PVOL 10P and/or the SVOL 10S may store therein the compressed data. Each of the JVOL 10JP and the JVOL 10JS may store therein the decompressed data.

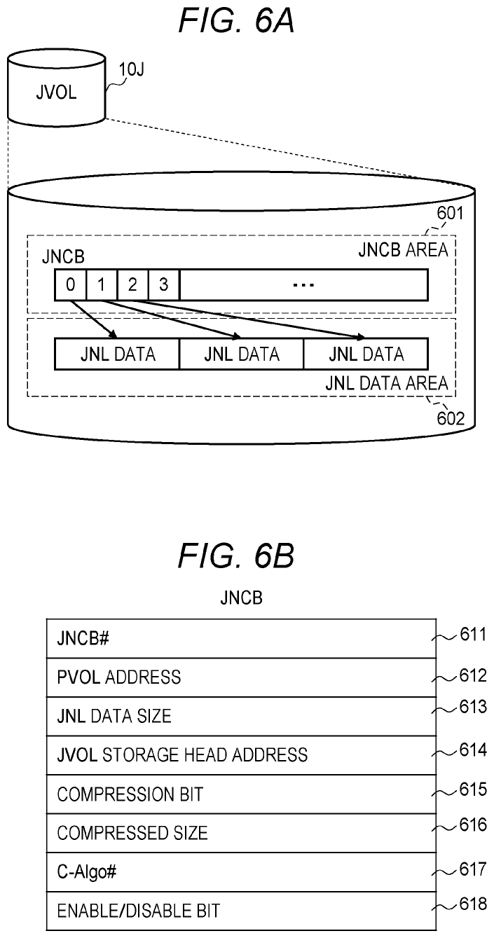

FIG. 6A illustrates a configuration example of the JVOL 10J.

The JOVL 10J includes a JNCB area 601 for storing JNCBs, and a JNL data area 602 for storing JNL data. A JNCB and JNL data are in a one-to-one corresponding relationship.

FIG. 6B illustrates a configuration example of the JNCB.

This JNCB 651 includes information such as a JNCB# 611, a PVOL address 612, a JNL data size 613, a JVOL storage head address 614, a compression bit 615, a compressed size 616, a C-Algo# 617, and a valid/invalid bit 618.

The JNCB# 611 indicates an identification number of a JNCB. The JNCB# 611 may be a serial number or a time stamp of the JNCB, for example. Data from the JVOL 10JS may be stored in the SVOL 10S in the order of the JNCB# 611 (for example, in the same order as the order in which the data is stored in the PVOL 10P).

The PVOL address 612 indicates the VOL number of the PVOL 10P, and the LBA of the area of the copy source in the PVOL 10P. The JNL data size 613 indicates the size (data length) of the corresponding JNL data (plaintext data). The JVOL storage head address 614 indicates the head address (LBA) of the storage area (the area where the corresponding JNL data is stored) in the JNL data area 602. The compression bit 615 indicates whether the corresponding JNL data is compressed. The compressed size 616 indicates the size (data length) of the compressed data of the corresponding JNL data. The C-Algo# 617 indicates the identification information of the C-Algo used in compressing the corresponding JNL data. The valid/invalid bit 618 indicates whether the JNCB is valid or invalid. For the valid/invalid bit 618, “valid” means that the JNCB and the JNL data corresponding to the JNCB are to be transferred to the secondary storage 110S. Once the JNCB and the JNL data corresponding to the JNCB are transferred to the secondary storage 110S, the PCTL 11P may update the valid/invalid bit 618 of the JNCB from “valid” to “invalid”.

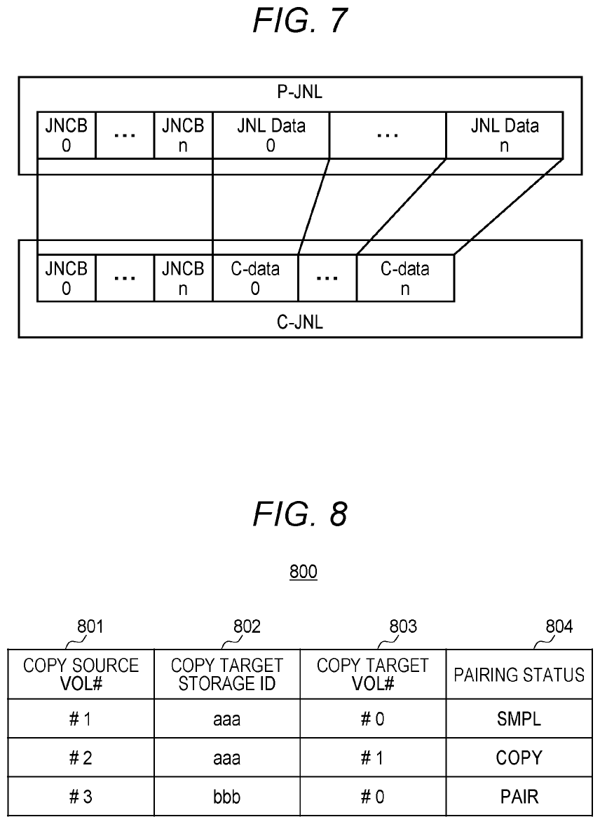

FIG. 7 illustrates an example of a corresponding relationship between the C-JNL and the P-JNL.

Each of the C-JNL and the P-JNL is logically partitioned into a meta-part and a data part. Each of the JNCB and the JNL data may have a nested structure. The meta-part is a set of N JNCBs, and the data part is a set of N pieces of JNL data. A JNCB and each piece of JNL data are in a one-to-one relationship.

The data part of the P-JNL is the part to be compressed. In other words, the size of the meta-part remains the same before and after the compression, but the size of the data part changes, because each piece of JNL data is compressed. In other words, after the compression, the PCTL 11P updates the compression bit 615 of the JNCB to “1” (value indicating compressed), updates the compressed size 616 to a value representing the size of the corresponding C-Data (compressed JNL data), and updates the C-Algo# 617 to the identification information of the C-Algo used in the compression.

Several tables will now be described below.

FIG. 8 illustrates a configuration example of a pair management table 800.

The pair management table 800 is a table stored in the memory 215 of the primary storage 110P. The pair management table 800 indicates which VOLs form a VOL pair. For example, the pair management table 800 has a record corresponding to each VOL pair. The record includes information such as a copy source VOL# 801, a copy target storage ID 802, a copy target VOL# 803, and a pairing status 804.

The copy source VOL# 801 indicates the VOL number of the PVOL 10P. The copy target storage ID 802 indicates the ID of the storage including the SVOL 10S. The copy target VOL# 803 indicates the VOL number of the SVOL 10S.

The pairing status 804 indicates the status of the VOL pair. For example, “SMPL” means a status prior to the initial copying. “COPY” means a status during the initial copying. “PAIR” means a status subsequent to the completion of the initial copying (regular copying status (status for which only the write data received from the host is copied)).

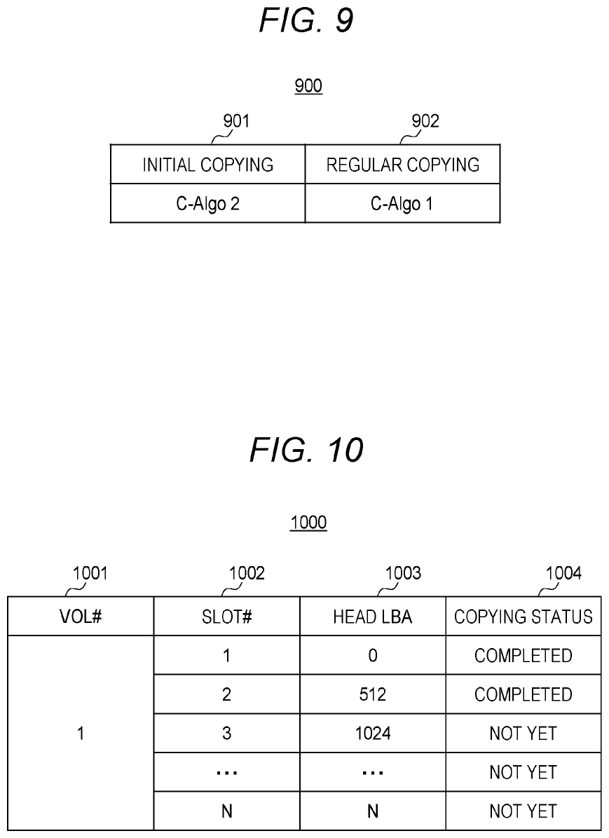

FIG. 9 illustrates a configuration example of an algorithm management table 900.

The algorithm management table 900 is a table stored in the memory 215 of the primary storage 110P. The algorithm management table 900 may be prepared for each pair of the primary storage 110P and the secondary storage 110S. The algorithm management table 900 indicates the C-Algo used in compressing JNLs. For example, the algorithm management table 900 includes information such as initial copying 901 and regular copying 902.

The initial copying 901 indicates the identification information of the C-Algo used in the initial copying. The regular copying 902 indicates the identification information of the C-Algo used in the regular copying.

FIG. 10 illustrates a configuration example of a VOL management table 1000.

The VOL management table 1000 is a table stored in the memory 215 of the primary storage 110P. The VOL management table 1000 indicates the areas of the PVOL 10P for which the initial copying has been completed. For example, the VOL management table 1000 includes a record corresponding to each PVOL 10P, and the record includes not only a VOL# 1001 that is information indicating the VOL number of the PVOL 10P, but also a sub-record corresponding to each slot. The sub-record includes information such as a slot# 1002, a head LBA 1003, and a copying status 1004.

The “slot” is a unit area in a VOL (an area having a predetermined size (for example, 256 KB)). The slot# 1002 indicates a slot number. The head LBA 1003 indicates an offset from the head LBA of the PVOL 10P. The copying status 1004 indicates whether the data in the slot has been copied.

For example, during the initial copying, data is transferred in units of slots, in ascending order of the slot#. The copying status 1004 corresponding to the slot for which the transfer to the secondary storage 110S is completed is updated from “not yet” to “completed”. When the copying statuses 1004 of all the slots of the PVOL 10P are “not yet”, the pairing status 804 is set to “SMPL”. If the copying status 1004 “not yet” and the copying status 1004 “completed” are mixed for the PVOL 10P, the pairing status 804 is set to “COPY”. When the copying statuses 1004 of all slots of the PVOL 10P are “completed”, the pairing status 804 is set to “PAIR”.

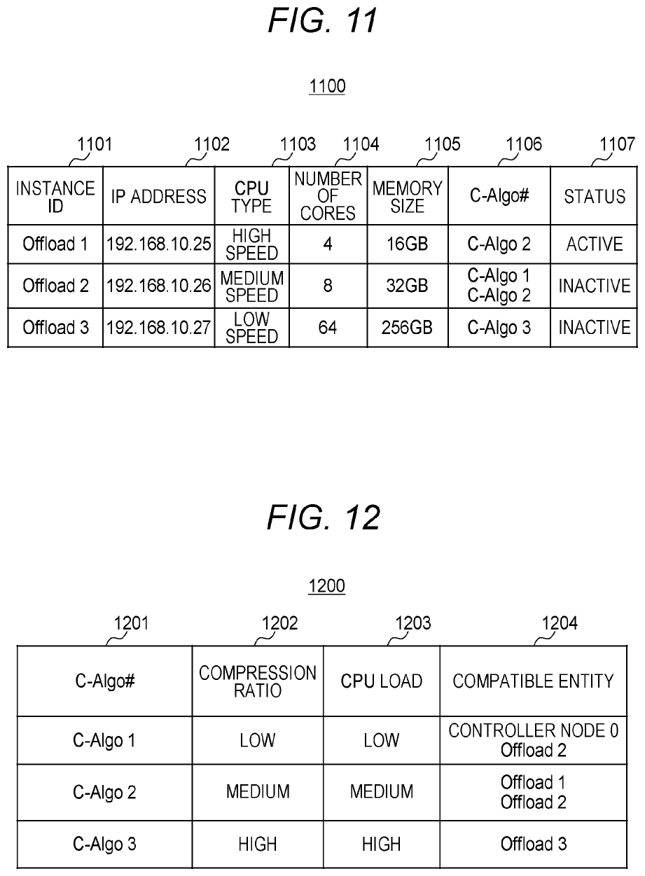

FIG. 11 illustrates a configuration example of an offload instance management table 1100.

The offload instance management table 1100 is a table included in tables 312 (see FIG. 3). The offload instance management table 1100 may be set from the management terminal 2. The offload instance management table 1100 is a list of offload instances 150 that are available to the secondary storage 110S. For example, the offload instance management table 1100 has a record corresponding to each of such offload instances 150. The record includes information such as an instance ID 1101, an IP address 1102, a CPU type 1103, the number of cores 1104, a memory size 1105, a C-Algo# 1106, and a status 1107.

The instance ID 1101 indicates an ID of the offload instance 150. The IP address 1102 indicates the IP address of the offload instance 150. The CPU type 1103 indicates the type (e.g., performance) of the CPU 402 (specifically, of the physical CPU on which the CPU 402 is based, for example) corresponding to the offload instance 150. The number of cores 1104 indicates the number of CPU cores of the CPU 402 corresponding to the offload instance 150 (specifically, the number of physical CPU cores on which the CPU 402 is based, for example). The memory size 1105 indicates the size of the memory 401 (specifically, of the physical memory on which the memory 401 is based, for example) corresponding to the offload instance 150. The C-Algo# 1106: indicates identification information of each of one or more C-Algos that are supported by the offload instance 150.

The status 1107 indicates whether the offload instance 150 is activate or inactivate. The status 1107 “active” means that the offload instance 150 is active (operating), and thus, a status in which a cost is being incurred for the offload instance 150 (for example, a state in which a physical resource based on the offload instance 150 is being consumed). The status 1107 “inactive” means that the offload instance 150 is inactivated, and hence, no cost is being incurred for the offload instance 150 (for example, a state in which no physical resource based on the offload instance 150 is being consumed).

FIG. 12 illustrates a configuration example of a support management table 1200.

The support management table 1200 is included in the tables 312 (see FIG. 3). The support management table 1200 indicates a list of C-Algos supported by the secondary storage 110S and by one or more offload instances 150 that are available to the secondary storage 110S. For example, the support management table 1200 has a record corresponding to each one of such C-Algos. The record includes information such as a C-Algo# 1201, a compression ratio 1202, a CPU load 1203, and a compatible entity 1204.

The C-Algo# 1201 indicates the identification information of the C-Algo. The compression ratio 1202 indicates the compression ratio (e.g., the level of a compression ratio, such as low, medium, or high, or an average compression ratio) of the C-Algo. Any value may be used as the compression ratio 1202. The CPU load 1203 indicates the degree of the CPU load accrued in executing the C-Algo (for example, a load level such as low, medium, or high, or an average CPU usage rate). The compatible entity 1204 indicates identification information of the controller node 385 and/or the identification information of the offload instance 150 supporting the C-Algo.

An example of processing performed in the present embodiment will be described below.

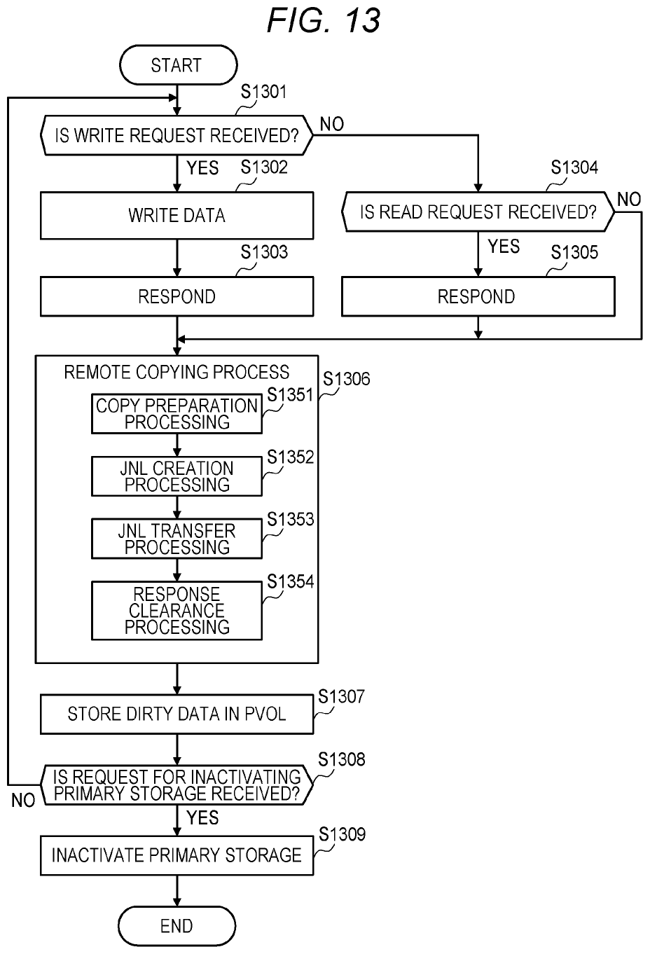

FIG. 13 illustrates the sequence of main task processing.

If a write request designating a PVOL 10P is received from a host 51 (S1301: Yes), the PCTL 11P caches the data in the memory 215, in accordance with the write request (S1302), and returns a completion response to the host 51 (S1303).

If a read request designating a PVOL 10P is received from a host 51 (S1301: No and S1304: Yes), the PCTL 11P reads the data from the PVOL 10P to the memory 215, in accordance with the read request, and responds with (transfers) the data having been read onto the memory 215, to the host 51 (S1305).

After S1303, after S1305, or if S1304: No (if the PCTL 11P receives neither a write request nor a read request), remote copying processing is executed (S1306). The remote copying processing includes copy preparation processing (S1351), JNL creation processing (S1352), JNL transfer processing (S1353), and response clearance processing (S1354).

After S1306, the PCTL 11P stores dirty data on the memory 215 (the data cached but not stored in the PVOL 10P) in the PVOL 10P (S1307). If there is no request for inactivating the primary storage 110P (S1308: No), the process returns to S1301. If a request for inactivating the primary storage 110P is received (S1308: Yes), the PCTL 11P inactivates the primary storage 110P (S1309).

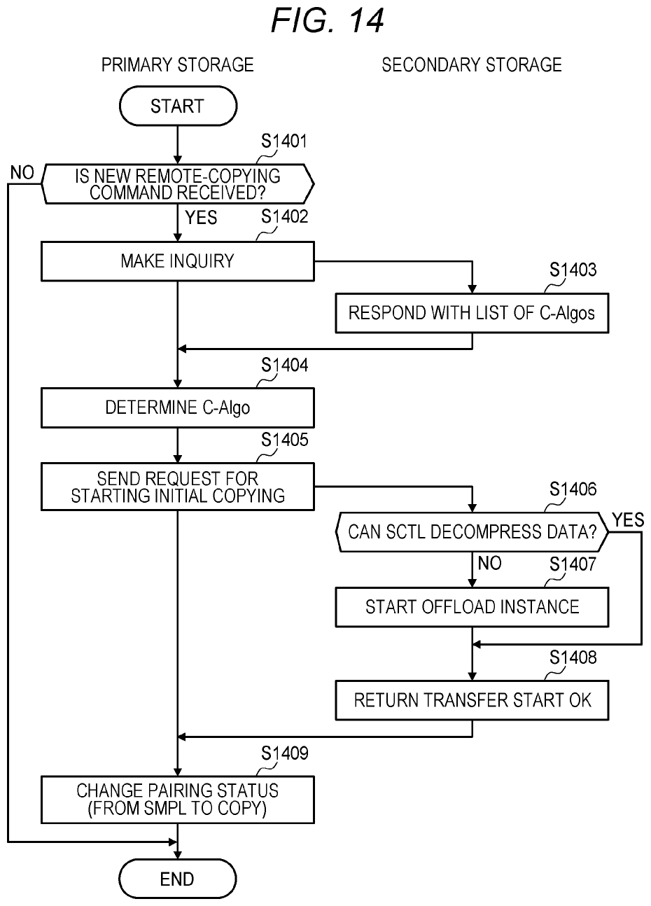

FIG. 14 illustrates the sequence of the copy preparation processing (S1351 in FIG. 13).

If a new remote-copying command is received (S1401: Yes), the PCTL 11P transmits an inquiry about the C-Algo supported by the secondary storage 110S to the secondary storage 110S (S1402). The “new remote-copying command” may be a remote-copying command for a VOL pair for which initial copying has not been performed yet. The remote-copying command may designate information of the PVOL 10P (e.g., information indicating the ID of the primary storage 110P including the PVOL 10P, and the VOL number of the PVOL 10P) and information of the SVOL 10S (e.g., information indicating the ID of the secondary storage 110S including the SVOL 10S, and the VOL number of the SVOL 10S). The “secondary storage 110S” referred to in this paragraph is the secondary storage 110S that includes the SVOL 10S designated in the remote-copying command.

In response to the inquiry, the SCTL 11S in the secondary storage 110S returns the support management table 1200 to the PCTL 11P that is the sender of the inquiry (S1403).

The PCTL 11P receives the support management table 1200, and determines the C-Algos to be used in the initial copying and the regular copying, respectively, for the VOL pair designated in the new remote-copying command, from the support management table 1200 (S1404). For example, the PCTL 11P may identify the C-Algo corresponding to the compression ratio 1202 “high” (C-Algo having the highest compression ratio), as the C-Algo used for the initial copying, among the C-Algos supported by both of the secondary storage 110S or the offload instance 150 and the primary storage 110P. As the C-Algo used in the regular copying, by contrast, the PCTL 11P may identify the C-Algo having the highest evaluation value that is based on the compression ratio 1202 and the CPU load 1203 (e.g., the C-Algo having the highest compression ratio, the C-Algo having the lowest CPU load, or the C-Algo having the best balance of the compression ratio and the CPU load), among the C-Algos supported by both of the secondary storage 110S and the primary storage 110P.

The PCTL 11P then transmits a request to start the initial copying between the PVOL 10P and the SVOL 10S designated in the new remote-copying command, to the secondary storage 110S including the SVOL 10S (S1405). The PCTL 11P maps the identification information (C-Algo# ) of the C-Algo to be used in the initial copying (C-Algo determined in S1404) to the request.

In response to the start request, the SCTL 11S (for example, the offload processing program 413) refers to the support management table 1200, and determines whether the SCTL 11S can decompress data (S1406). In the determination in S1406, the SCTL 11S determines whether any of the controller nodes 385 of the secondary storage 110S is included in the identification information specified in the compatible entity 1204 corresponding to the C-Algo# mapped to the start request.

If the determination result in S1406 is false (S1406: No), the SCTL 11S activates offload the instance 150 (S1407). Specifically, the SCTL 11S identifies an offload instance 150 from the compatible entity 1204 supporting the C-Algo# mapped to the start request. The SCTL 11S refers to the offload instance management table 1100, and activates the identified offload instance 150 (e.g., activates the identified offload instance 150 based on the IP address 1102 corresponding to the offload instance 150). The SCTL 11S also updates the status 1107 corresponding to the offload instance 150 to “active”. If the compatible entity 1204 supporting the C-Algo# mapped to the start request indicates a plurality of offload instances 150, one of the offload instances 150 may be selected based on the CPU type 1103, the number of cores 1104, and the memory size 1105 of each of the offload instances 150.

If the determination result in S1406 is true (S1406: Yes), or after S1407, the SCTL 11S returns transfer start OK to the PCTL 11P (S1408).

Upon receiving the transfer start OK, the PCTL 11P updates the pairing status 804 (see FIG. 8) corresponding to the VOL pair designated in the new remote-copying command to “COPY” (S1409).

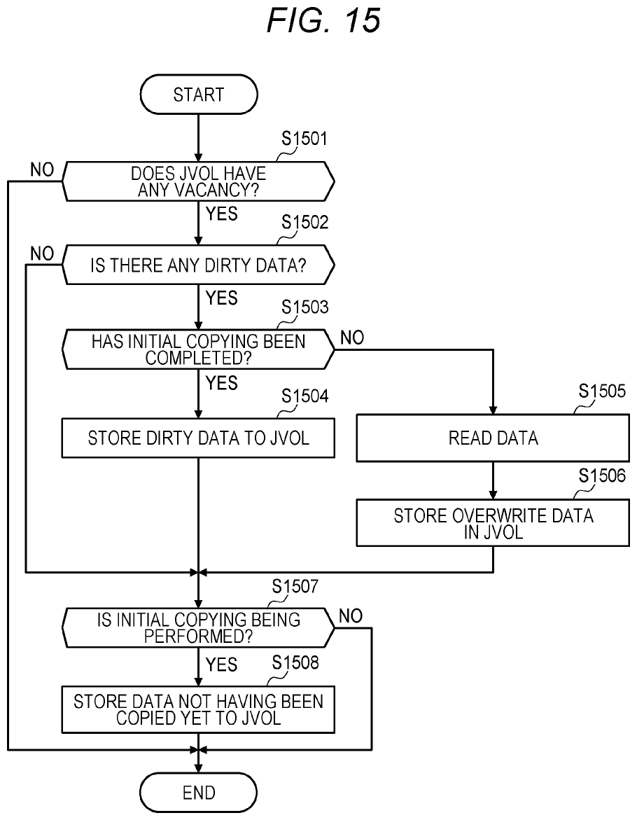

FIG. 15 illustrates the sequence of the JNL creation processing (S1352 in FIG. 13).

The PCTL 11P determines whether the JVOL 10JP has any vacancy (S1501). For example, the PCTL 11P may determine true in S1501 if there is at least one JNCB having “invalid” in the valid/invalid bit 618.

If the determination result in S1501 is true (S1501: Yes), the PCTL 11P determines whether there is dirty data in the memory 215 (S1502). If the determination result in S1502 is true (S1502: Yes), the PCTL 11P determines whether the initial copying of the dirty data has been performed (whether the copying status 1004 corresponding to the storage slot where the dirty data is stored is set to “completed”) (S1503).

If the determination result in S1503 is true (S1503: Yes), the PCTL 11P stores the dirty data as JNL data in the JVOL 10JP (S1504).

If the determination result in S1503 is false (S1503: No), the PCTL 11P reads the data from the storage slot where the dirty data is stored, overwrites the read data with the dirty data (S1505), and stores the data overwritten with the dirty data in the JVOL 10JP as JNL data (S1506).

After S1504 or S1506, the PCTL 11P determines whether the initial copying is being performed (S1507). For the determination in S1507, the PCTL 11P determines whether the copying status 1004 “completed” and the copying status 1004 “not yet” are mixed, for the PVOL 10P from which the data is being copied.

If the determination result in S1507 is true (S1507: Yes), the PCTL 11P stores the data in each slot for which copying has not been completed (slot corresponding to the copying status 1004 “not yet”) in the JVOL 10JP (S1508).

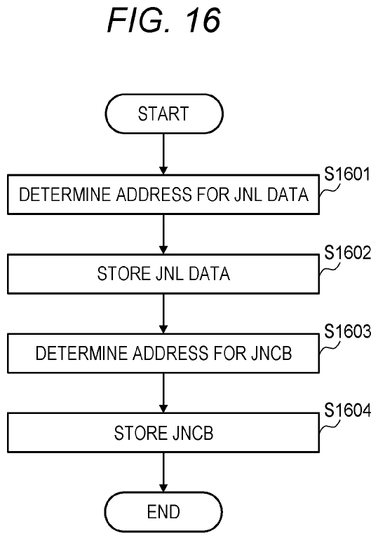

FIG. 16 illustrates the sequence of JVOL storing processing.

This JVOL storing processing is the specific processing of each of S1504, S1506, and S1508 in FIG. 15. That is, the PCTL 11P determines an address for the JNL data (data to be stored in the JVOL 10JP) (S1601). The determined address may be, for example, the address specified in the JVOL storage head address 614 corresponding to a JNCB having “invalid” in the valid/invalid bit 618. The size of the JNL data may be the same as the size of the slot.

The PCTL 11P stores the JNL data in the area indicated by the address determined in S1601 (an area in the JVOL 10JP) (S1602).

The PCTL 11P also determines the address for the JNCB (S1603). The address determined may be, for example, the address of a JNCB having “invalid” in the valid/invalid bit 618. The PCTL 11P stores the JNCB in the address determined in S1603 (S1604). Specifically, for example, the PCTL 11P may set, for the JNCB, the address of the PVOL slot (slot in the PVOL 10P) where the JNL data is stored in S1602 as the PVOL address 612; set the size of the stored data (e.g., the slot size) to the JNL data size 613; set “0” (uncompressed) to the compression bit 615; set blanks to the compressed size 616 and C-Algo# 617; and set “valid” to the valid/invalid bit 618.

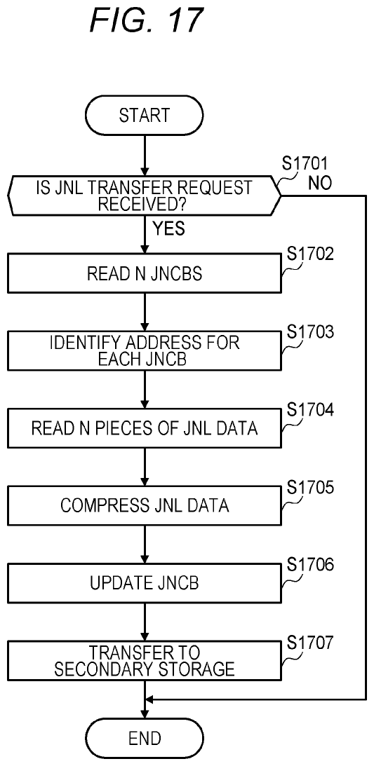

FIG. 17 illustrates the sequence of the JNL transfer processing (S1353 in FIG. 13).

The secondary storage 110S (or the management terminal 2) transmits a JNL transfer request to the primary storage 110P regularly, or when the capacity available in the JVOL 10JS is equal to or more than a predetermined value. Upon receiving the JNL transfer request from the secondary storage 110S (or the management terminal 2) (S1701: Yes), the PCTL 11P reads N JNCBs from the JVOL 10JP (S1702). For example, the N JNCBs are NUNCBs having the valid/invalid bit 618 set to “valid” and having smaller JNCB#s 611.

The PCTL 11P identifies the JVOL storage head address 614 for each of the N JNCBs read in S1702 (S1703), and reads the N pieces of JNL data (S1704). The PCTL 11P compresses each of the N pieces of JNL data read in S1704 using the C-Algo identified from the algorithm management table 900, and updates each of the N JNCBs read in S1702 (S1706). The PCTL 11P then transfers the C-JNL including the N JNCBs and the N pieces of compressed data to the secondary storage 110S.

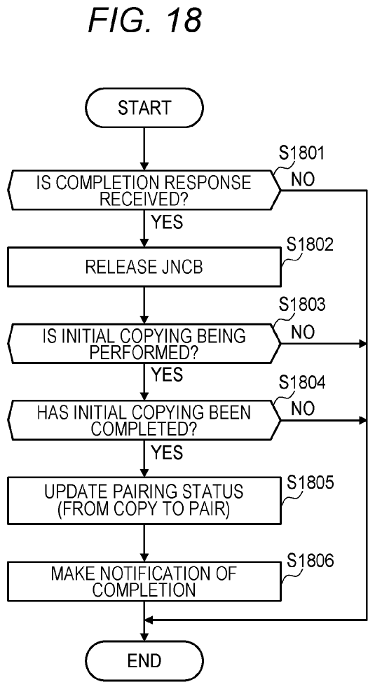

FIG. 18 illustrates the sequence of response clearance processing (S1354 in FIG. 13).

Upon receiving the completion response for the transfer of the C-JNL from the secondary storage 110S (S1801: Yes), the PCTL 11P releases the JNCB in the JVOL 10JP (S1802). Specifically, the PCTL 11P sets the valid/invalid bit 618 to “invalid” for each of the N JNCBs corresponding to the transferred C-JNL, in the JVOL 10JP.

If the initial copying is currently being performed (S1803: Yes), the PCTL 11P determines whether the initial copying has been completed, specifically, whether all of the copying statuses 1004 are “completed” for the PVOL 10P (S1804).

If the determination result in S1804 is true (S1804: Yes), the PCTL 11P updates the pairing status 804 corresponding to the PVOL 10P to “COPY” (S1805), and notifies the secondary storage 110S of the completion of the initial copying (S1806).

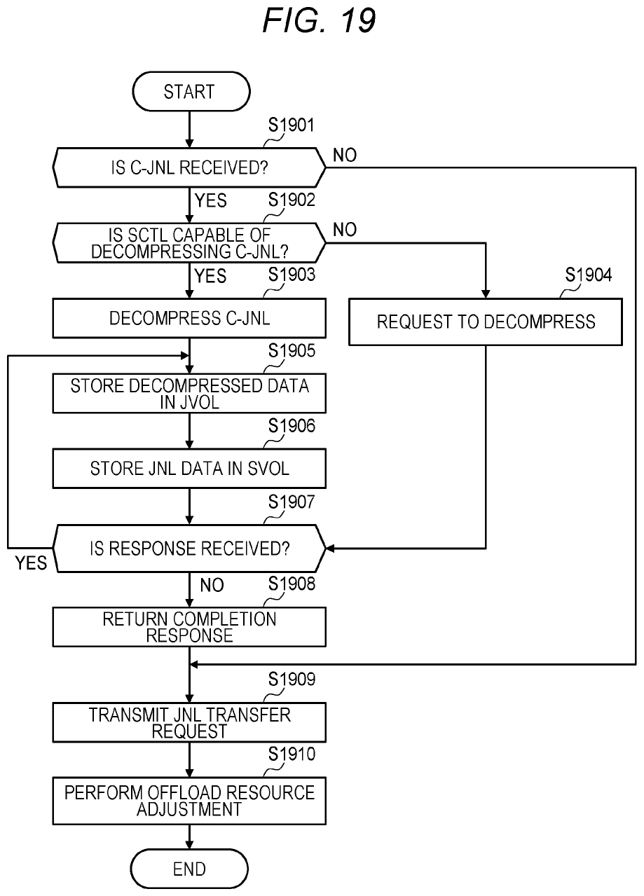

FIG. 19 illustrates the sequence of secondary copying processing.

The secondary copying processing may be started regularly. Upon receiving a C-JNL (JNL including the JNCB having the compression bit 615 set to “1”) (S1901: Yes), the SCTL 11S determines whether the SCTL 11S can decompress the C-JNL, specifically, whether any of the controller nodes 385 of the SCTL 11S is included in the identification information specified in the compatible entity 1204 having the same C-Algo# as the C-Algo# 617 in the JNCB of the C-JNL (S1902). In the description of FIGS. 19 to 21, the C-Algo identified from the C-Algo# 617 in the JNCB of the C-JNL will be referred to as a “pertinent C-Algo”. The controller node 385 that supports the pertinent C-Algo and is selected from the compatible entities 1204 will be referred to as a “selected controller node 385”. The offload instance 150 that supports the pertinent C-Algo and is selected from the compatible entities 1204 will be referred to as a “selected offload instance 150”.

If the determination result in S1902 is true (S1902: Yes), the selection controller node 385 of the SCTL 11S decompresses each piece of the compressed data C-JNL using the pertinent C-Algo (S1903). The SCTL 11S stores the P-JNL including the pieces of decompressed data (JNL data) in the JVOL 10JS (S1905). The SCTL 11S stores the pieces of the JNL data in the JVOL 10J (JNL data having “valid” set to the valid/invalid bit 618 of the corresponding JNCB) in the SVOL 10S (S1906).

If the determination result in S1902 is false (S1902: No), the SCTL 11S transmits a decompression request with the C-JNL mapped thereto, to the selected offload instance 150 (S1904). If a response including the P-JNL containing the decompressed data is received from the selected controller node 385 (S1907: Yes), the SCTL 11S stores the P-JNL in the JVOL 10JS (S1905), and stores the pieces of JNL data in the JVOL 10J, in the SVOL 10S (S1906).

The SCTL 11S then returns a completion response for the received C-JNL to the primary storage 110P (S1908). Note that S1906 may be performed (the JNL data may be reflected to the SVOL 10S) at any timing after S1908.

For example, after a certain period of time has elapsed from S1908 (or after a certain period of time has elapsed from when the secondary copying processing is started), the SCTL 11S transmits a JNL transfer request to the primary storage 110P (S1909). The SCTL 11S performs offload resource adjustment that is adjustment of the amount of resource of the offload instances 150 (S1910). Note that S1910 may be a process asynchronous to the secondary copying processing (another process).

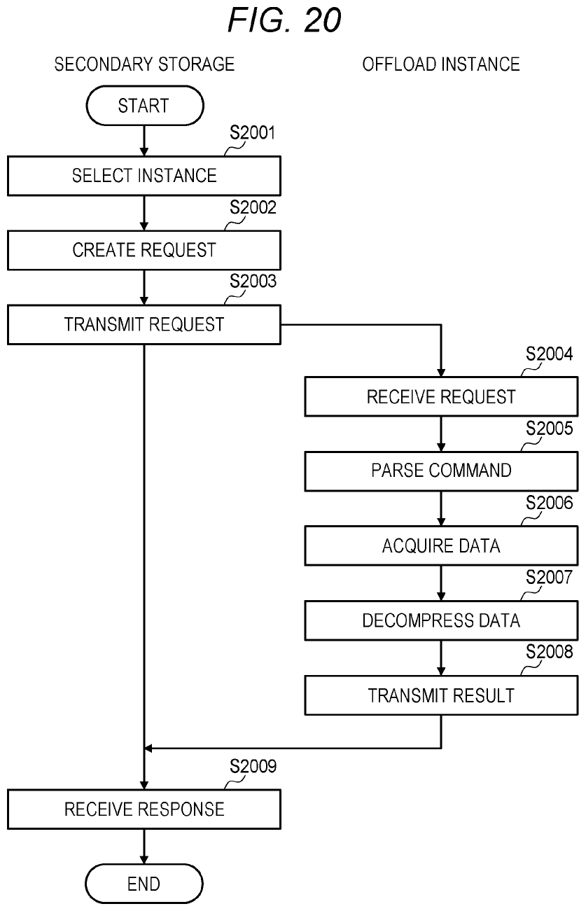

FIG. 20 illustrates the sequence of decompression request processing.

The decompression request processing is the specific processing of S1904 in FIG. 19. The SCTL 11S selects an offload instance 150 from the compatible entity 120 corresponding to the pertinent C-Algo (S2001). The SCTL 11S creates a decompression request with the C-JNL mapped thereto (S2002), and transmits the decompression request to the selected offload instance 150. In the decompression request, the pertinent C-Algo is specified.

The selected offload instance 150 (for example, the offload processing program 413) receives the decompression request (S2004) and parses the decompression request (S2005). The selected offload instance 150 acquires each piece of compressed data from the C-JNL (S2006), decompresses the pieces of the compressed data using the pertinent C-Algo (S2007), and returns the P-JNL including pieces of the decompressed data to the secondary storage 110S (S2008).

The SCTL 11S receives the P-JNL from the selected offload instance 150 (S2009).

Note that the SCTL 11S may transmit each pieces of the compressed data included in the C-JNL to the selected offload instance 150, receive the corresponding decompressed data from the selected offload instance 150, and generate a P-JNL including the received piece of decompressed data.

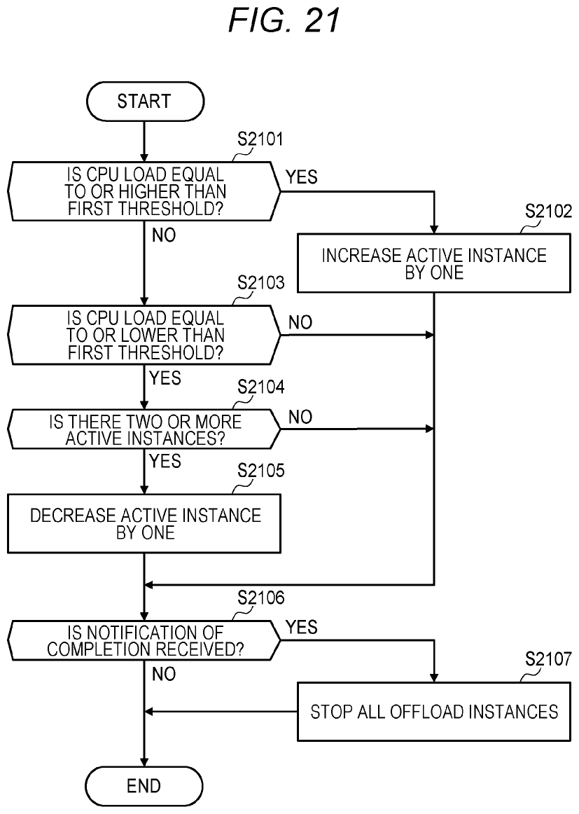

FIG. 21 illustrates the sequence of offload resource adjustment processing.

The offload resource adjustment processing is the specific processing of S1910 in FIG. 19. The SCTL 11S determines whether the CPU load (for example, the CPU utilization rate) corresponding to each active instance 150 is equal to or higher than a first threshold (S2101). An “active instance 150” is an offload instance 150 having an “active” status 1107.

If the determination result in S2101 is true (S2101: Yes), the SCTL 11S increments the number of the active instances 150 by one (S2102). That is, the SCTL 11S changes any one of the “inactive” status 1107 to “active”.

If the determination result in S2101 is false (S2101: No), the SCTL 11S determines whether the CPU load of each active instance 150 is equal to or lower than a second threshold (S2103). The second threshold is lower than the first threshold.

If the determination result in S2103 is true (S2103: Yes), the SCTL 11S determines whether there are two or more active instances 150 (S2104).

If the determination result in S2104 is true (S2104: Yes), the SCTL 11S decrements the number of the active instances 150 by one (S2105). That is, the SCTL 11S changes one of the “active” statuses 1107 to “inactive”.

The SCTL 11S determines whether a notification of the completion of the initial copying is received from the primary storage 110P (S2106). If a notification of the completion of the initial copying is received from the primary storage 110P (S2106: yes), the SCTL 11S sets the statuses 1107 of all of the offload instances 150 to “inactive” (S2107).

### Second Embodiment

A second embodiment will now be described. In the description, differences with respect to the first embodiment will be mainly explained, and descriptions of the matters that are the same as those in the first embodiment will be omitted or simplified (the same applies to the following third to fifth embodiments).

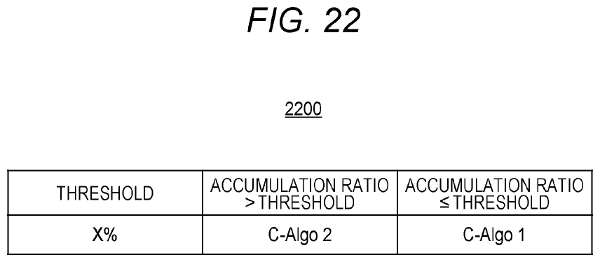

FIG. 22 illustrates a configuration example of an algorithm selection table 2200 according to the second embodiment.

The algorithm selection table 2200 is a table stored in the memory 215 of the primary storage 110P. The algorithm selection table 2200 specifies the C-Algo used in compressing JNL data. The algorithm selection table 2200 also specifies a threshold X for the accumulation ratio for the JVOL 10JP, the identification information of the C-Algo to be selected when the accumulation ratio>the threshold X, and the identification information of the C-Algo to be selected when the accumulation ratio≤the threshold X.

The “accumulation ratio” is a ratio of the sum of the sizes of the JNL data corresponding to all of the JNCBs having “valid” set to the valid/invalid bit 618, with respect to the size of the JNL data area 602.

The algorithm selection table 2200 may be applied to both of the initial copying and the regular copying, but, in the present embodiment, the algorithm selection table 2200 is applied to the regular copying. If the accumulation ratio>the threshold X is detected during the regular copying, it is necessary to accelerate the transfer, and thus, the C-Algo having a high compression ratio is selected. By contrast, if the accumulation ratio≤threshold X is detected, the transfer acceleration is not necessary, and therefore, a common C-Algo (C-Algo supported by both of the primary storage 110P and the secondary storage 110S) is selected.

Specifically, during the JNL transfer processing in the regular copying (see FIG. 17), the PCTL 11P calculates the accumulation ratio of the JVOL 10JP in S1705, selects C-Algo based on the result of comparison between the accumulation ratio and the threshold X, and compresses the N pieces of JNL data read in S1704 using the C-Algo.

### Third Embodiment

In a third embodiment, a reverse copying direction, that is, the direction from the cloud storage to the on-premises storage is used, instead of or in addition to the copying direction from the on-premises storage to the cloud storage. In such a case, the cloud storage has the functions of the primary storage, the PVOL, and the JVOL, and the on-premises storage has the functions of the secondary storage, the SVOL, and the SVOL.

If there is any high-compression ratio C-Algo (e.g., C-Algo 2) that is supported by the on-premises storage but not supported by the cloud storage, and has a higher compression ratio than the C-Algo supported in cloud storage, the cloud storage causes, for the initial copying, the offload instance 150 supporting the high-compression ratio C-Algo to compress each piece of the JNL data in the P-JNL using the high-compression ratio C-Algo. The cloud storage transfers the C-JNL including the pieces of compressed data compressed by the offload instance 150 to the on-premises storage. The on-premises storage decompresses each piece of the compressed data C-JNL using the high-compression ratio C-Algo supported by the on-premises storage, stores the P-JNL including the pieces of the decompressed data in the JVOL, and stores the pieces of JNL data in the JVOL in the SVOL.

### Fourth Embodiment

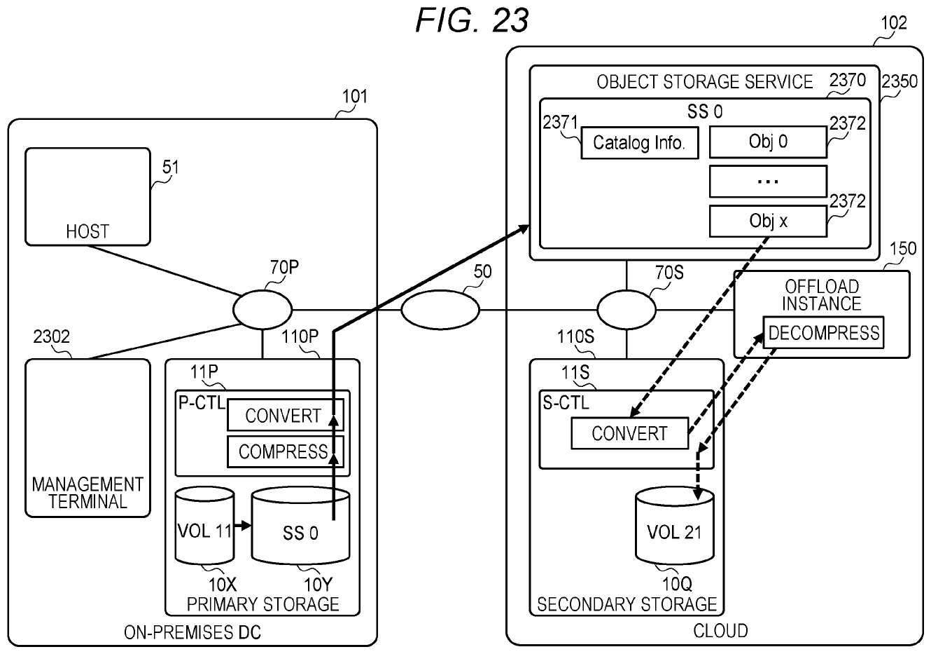

FIG. 23 schematically illustrates an overview of an example of remote copying according to a fourth embodiment.

The on-premises DC 101 includes a network 70P (e.g., a network including one or more switches) and a management terminal 2302. The management terminal 2302, the host 51, and the primary storage 110P communicate with one another via the network 70P.

The cloud 102 includes a network 70S (e.g., a network including one or more switches) and an object storage (object storage service) 2350. The object storage 2350, the offload instance 150, and the secondary storage 110S (storage including a storage node as a block storage service) communicate via the network 70S.

In FIG. 23, the arrow in a solid line indicates a backup sequence, and the arrows in broken lines indicate a restoration sequence. That is, in the present embodiment, a backup of the VOL 10 is taken from the primary storage 110P to the object storage 2350, and the backup is restored from the object storage 2350 to the secondary storage 110S. Each of the PCTL 11P and the SCTL 11S has a function for converting a data block to an object (data object) and vice versa.

The PCTL 11P captures a snapshot VOL 10Y, which is a snapshot of a VOL 10X (corresponding to the PVOL 10P), as a backup copy of the VOL 10X. One or more snapshots VOL 10Y are prepared for the one VOL 10X.

The PCTL 11P compresses m data blocks (where m is an integer equal to or more than one) included in the snapshot VOL 10Y, using a C-Algo. When the snapshot VOL 10Y corresponds to the entire data of the VOL 10X, and the backup to the object storage 2350 is what is called full backup, the C-Algo corresponding to the initial copying may be used as the C-Algo. By contrast, when the snapshot VOL 10Y is differential data of the VOL 10X (data corresponding to a difference from the past snapshot) and the backup to the object storage 2350 is what is called differential backup, either one of the C-Algo corresponding to the initial copying or the C-Algo corresponding to the regular copying may be used as the C-Algo.

The PCTL 11P converts the m compressed data blocks into x objects 2372 (where x is an integer equal to or more than one, and x≤m). Each of the objects 2372 includes n compressed data blocks (where n is an integer equal to or more than one, and n≤x≤m) and JNCBs corresponding to the respective compressed data blocks. The PCTL 11P stores a snapshot VOL 2370 including catalog information 2371 and the x objects 2327 in the object storage 2350. The snapshot VOL 2370 may be stored for each of the snapshot VOLS 10Y. The catalog information 2371 being included in the snapshot VOL 2370 is merely an example of the catalog information 2371 being mapped to the snapshot VOL 2370, and the catalog information 2371 may be located outside of the snapshot VOL2370.

For example, it is assumed herein that an administrator designates the snapshot VOL 2370 (e.g., the ID of the generation to be restored) and the secondary storage 110S to which the data is to be restored, to the secondary storage 110S (or the object storage 2350), via the management terminal 2302. The management terminal 2302 may be located outside the on-premises DC 101.

In response to the designation, the SCTL 11S restores a VOL 10Q, which is the same data as the VOL 10X, from the designated snapshot VOL 2350 of the object storage 2350, onto the secondary storage 110S. Specifically, the SCTL 11S acquires each of the x objects 2372 based on the catalog information 2371 in the snapshot VOL 2370, and converts each of the objects 2372 into n compressed data blocks. The SCTL 11S decompresses each of the compressed data blocks on the basis of the JNCB corresponding to the compressed data block. If the SCTL 11S itself supports the C-Algo identified from the JNCB, the SCTL 11S decompresses the compressed data block. If the SCTL 11S does not support the C-Algo identified from the JNCB, but the offload instance 150 supports the C-Algo, the SCTL 11S requests the offload instance 150 to decompress the compressed data block.

The SCTL 11S then stores each of the decompressed data blocks in the VOL 100 where the data is being restored. When the restoration of all of the data has been completed, the SCTL 11S may switch the statuses of all the offload instances 150 to inactive.

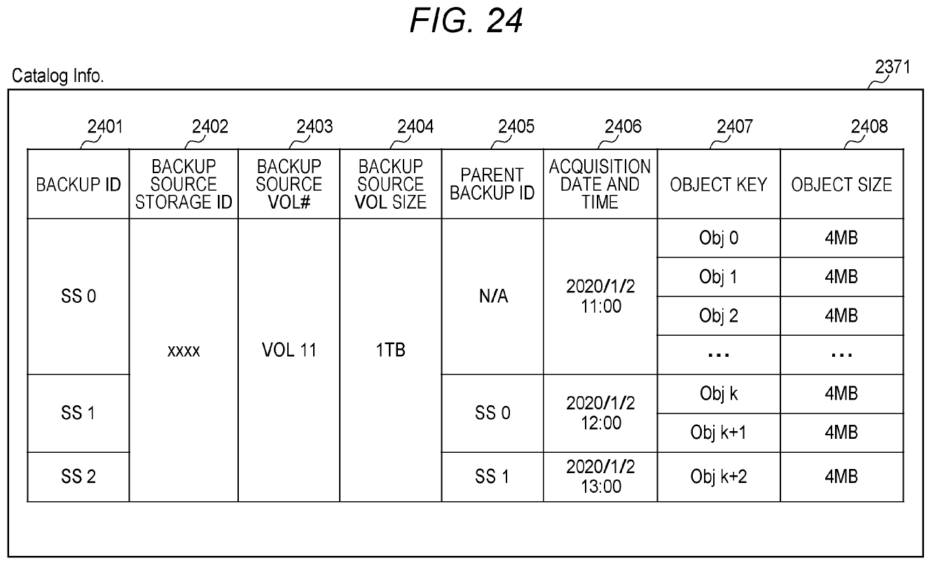

FIG. 24 illustrates a configuration example of the catalog information 2371.

The catalog information 2371 includes entries each including information such as a backup ID 2401, a backup source storage ID 2402, a backup source VOL# 2403, a backup source VOL size 2404, a parent backup ID, an acquisition date and time 2406, an object key 2407, and an object size 2408.

The backup ID 2401 may be a backup ID such a snapshot ID that is a generation ID. The snapshot ID may correspond to the VOL number of the snapshot VOL 10Y.

The backup source storage ID 2402 indicates the ID of the primary storage 110P that includes the VOL 10X that is the source VOL of the backup. The backup source VOL# 2403 indicates the VOL number of the VOL 10X. The backup source VOL size 2404 indicates the size (capacity) of the VOL 10X.

The parent backup ID indicates the backup ID of the snapshot belonging to a parent generation (previous generation) of the corresponding snapshot VOL. The acquisition date and time 2406 indicates the date and time at which the snapshot is acquired (the date and the time at which the VOL 10Y is created).

The object key 2407 indicates the storage (e.g., the address or the ID) where the object 2372 is stored. The object size 2408 indicates the size of the object 2372.

The catalog information 2371 may contain a larger amount of information for a later generation. For example, the catalog information 2371 illustrated in FIG. 24 may be the catalog information 2371 mapped to the snapshot VOL 2370 corresponding to a third generation (SS2). The catalog information 2371 mapped to the snapshot VOL 2370 corresponding to a second generation (SS1) may be the information without the information corresponding to the backup ID 2401 “SS2” included in the catalog information 2371 illustrated in FIG. 24.

In the example illustrated in FIG. 24, the snapshot VOL 2370 of the first generation VOL 10X (backup ID 2401 “SS0”) includes a plurality of objects 2372 including of all of the compressed data blocks corresponding to the VOL 10X. The snapshot VOL 2370 corresponding to the VOL 10X of the subsequent generation (the backup ID 2401 “SS1” with a parent backup ID 2405 “SS0”) includes two objects 2372 including compressed data blocks corresponding to the data blocks stored in the VOL 10X after the first-generation VOL 10X is created.

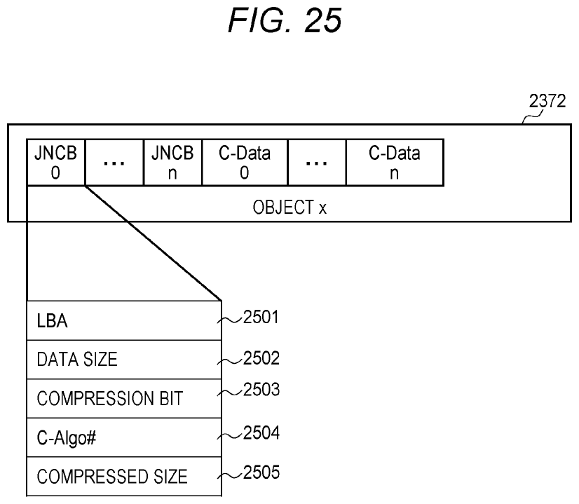

FIG. 25 illustrates a configuration example of the object 2372.

The object 2372 has the same configuration as the C-JNL. In other words, the object 2372 includes one or more compressed data blocks, and includes the JNCBs corresponding to the respective compressed data blocks.

The JNCB includes information such as an LBA 2501, a data size 2502, a compression bit 2503, a C-Algo# 2504, and a compressed size 2505. The LBA 2501 is an address of the area of the backup source VOL (VOL 10X), and indicates an address at which the plaintext data block corresponding to the compressed data block is stored. The data size 2502 indicates the size of the plaintext data block (or any size). The compression bit 2503 indicates whether the data is compressed. The C-Algo# 2504 indicates the identification information of the C-Algo used in the compression of the data block. The compressed size 2505 indicates the size of the compressed data block.

Every time the PCTL 11P compresses a plaintext data block acquired from the snapshot VOL 10Y using a C-Algo, the JNCB corresponding to the compressed data block is updated (e.g., the C-Algo# of the C-Algo used by the PCTL 11P is recorded in the JNCB). In addition, every time the snapshot VOL 2370 is stored, the PCTL 11P acquires the catalog information 2371 corresponding to the parent generation of the generation of the snapshot VOL 2370 (for the first generation snapshot, the catalog information 2371 is newly created), and updates the catalog information 2371.

To restore, the SCTL 11S refers to the catalog information 2371 mapped to the snapshot VOL 2370 corresponding to the designated generation, and acquires the objects 2372, converts the objects 2372 into n compressed data blocks, determines whether the SCTL 11S can decompress the compressed data blocks by itself, on the basis of the JNCB corresponding to each of the n compressed data blocks, decompresses the compressed data blocks by itself or by using the offload instance 150, and store the decompressed data blocks in the VOL 100, sequentially from an older generation to the designated generation.

### Fifth Embodiment

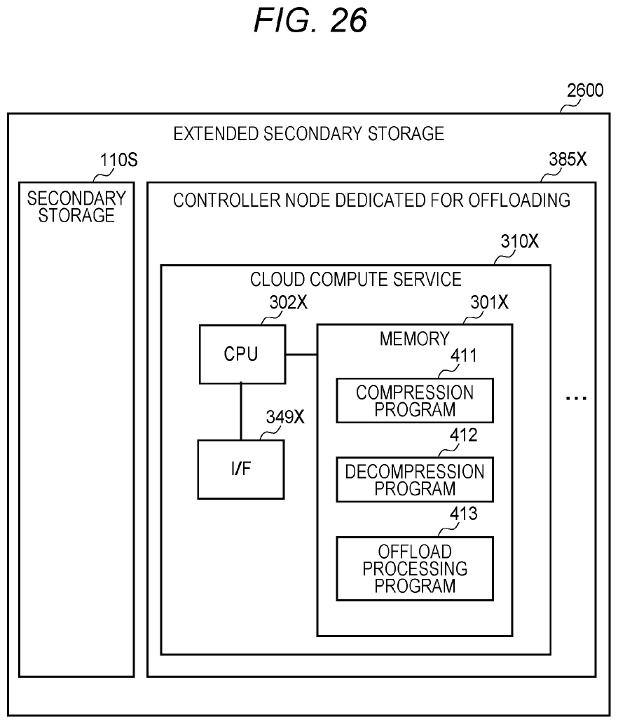

FIG. 26 illustrates a configuration example of an offload instance according to a fifth embodiment.

An extended secondary storage 2600 is built in the cloud 102. The extended secondary storage 2600 includes, in addition to the secondary storage 110S, a cloud compute service as an offload instance, specifically, a controller node 385X dedicated for offloading.

The controller node 385X has the same function as the offload instance 150. That is, the controller node 385X is a cloud compute service 310X, and the cloud compute service 310X includes an interface 349X, a memory 301X, and a CPU 302X. The interface 349X communicates with the secondary storage 110S (e.g., the controller node 385), for example. The memory 301X includes a compression program 411 for performing compression using a C-Algo supported by the controller node 385X, a decompression program 412 for performing decompression using the C-Algo supported by the controller node 385X, and an offload processing program 413 for receiving a decompression request. These programs 411 to 413 are executed by the CPU 302X. Note that the controller node 385X may dynamically activated or inactivated by the secondary storage 110S while the secondary storage 110S is in operation.

Although some embodiments have been described above, these are provided as examples for describing the present invention, and are not intended to limit the scope of the present invention only to these embodiments. The present invention may also be executed in various other forms, from the viewpoint of performing compression decompression using an offload instance. For example, according to the description of the first to fifth embodiments, one of the transmitting side and the receiving side of the remote copying supports a compression scheme executed by an offload instance, and the other does not support the compression scheme and therefore uses the offload instance to perform compression or decompression. However, both of the transmitting side and the receiving side may be configured in the cloud and neither may support the compression scheme, so that both of the storage systems may use the offload instance. In other words, it is possible to configure the transmitting-side storage system to use the offload instance to compress the data to be transferred, and to configure the receiving-side storage system to use the offload instance to decompress the received data.

Furthermore, offload instances may be configured to perform compression or decompression for purposes other than remote copying. For example, the offload instance may perform compression or decompression at the time of data input/output from the host. In other words, upon receiving a write request from the host, the storage system may store compressed data by causing the offload instance to compress the data using a compression scheme that is not supported by the storage system; and, upon receiving a read request for data from the host, the storage system may respond to the host by causing the offload instance to decompress the compressed data using the compression scheme that is not supported by the storage system.

The storage system may also be configured to compress or to decompress the data stored therein using an offload instance, and store the compressed or decompressed data, asynchronously to the data input/output request or remote copying.

The description above can be summarized as follows, for example. The following summary may include some supplementary descriptions and descriptions of modifications provided above.

The data transfer system includes a first storage (e.g., on-premises storage) that is a storage system and a second storage (cloud storage) that is a storage system in the cloud 102. The first storage and the second storage perform data transfer of data to be transferred, between the first storage and the second storage. In the data transfer, the second storage makes a compression/decompression determination (e.g., S1902) that is a determination as to whether the compression scheme used in compressing or decompressing the data to be transferred is a compression scheme supported by both of the first storage and the second storage. When the result of the compression/decompression determination is false, the second storage causes a selected offload instance 150 that is an offload instance supporting the compression scheme having been used to compress or decompress the data to be transferred, among one or more offload instances 150 residing on the cloud 102 and being available as an entity to which the compression or the decompression is to be offloaded (e.g S1904).

In this manner, even if the compression schemes supported by the first storage and the second storage are different, it is possible to implement compressed remote copying, so that the network load as well as the network power consumption can be reduced. Specifically, it is possible for the storage that is a receiver of the compressed data, which has been transferred between the first storage and the second storage, to decompress the compressed data.

As one comparative example, when there is a compression scheme supported by the first storage but not supported by the second storage, the controller instance on the second storage may be replaced with another controller instance that supports the compression scheme, as well as the existing compression scheme. However, the controller instance after the replacement may require a larger amount of resource, and, because the controller instance typically needs to be kept running while the second storage is in operation, the controller instance may consume a larger amount of resource.

The “compression scheme” may be a compression algorithm (C-Algo), and examples thereof include LZ4, ZIP, LZMA, LZO, and GZIP. The compression scheme may include a model (e.g., a machine learning model) used for compression or decompression, instead of or in addition to the compression algorithm. The compression may be lossless compression or lossy compression. When a lossy compression is used, “can be decompressed” may mean that decompressed data contains a predetermined amount of error or less, or that the compressed data is decompressed using a model the accuracy of which is at a certain level or higher.

Although the first storage may be on-premises storage, the first storage may also be a storage system outside the on-premises storage, e.g., a storage system in a cloud environment that is different from the cloud 102, or a near-cloud storage.

The data to be transferred that is data transferred between the first storage and the second storage may be data including a meta-part and a data part. The data part may be n pieces of compressed data (where n is an integer equal to or more than one). Each of the n pieces of compressed data may be data obtained by compressing data to be transferred. The meta-part may include information indicating the compression scheme used in compressing the data to be transferred. Among the first storage and the second storage, the storage having received the data to be transferred may identify the compression scheme required for decompressing the n pieces of compressed data of the data to be transferred, from the meta-part of the data to be transferred, and store the data resultant of decompressing each of the n pieces of compressed data using the identified compression scheme. As described above, because the data to be transferred includes the meta-part indicating the compression scheme used in compression, the storage having received the data to be transferred can identify the compression scheme required to decompress the data part of the data to be transferred.

The data to be transferred may be data transferred from the first storage to the second storage. Even if the data to be transferred is compressed by the first storage using a compression scheme not supported by the second storage, and is then transferred, the second storage may decompress the data part of the data to be transferred using the offload instance 150. For this reason, the first storage can use the compression scheme having the highest compression ratio, among the compression schemes supported by the first storage, regardless of whether the compression scheme is supported by the second storage, so that the time required for data transfer can be reduced, advantageously.

The first storage may be the primary storage 110P including the PVOL 10P that is the source VOL of the copying. The second storage may be the secondary storage 110S including the SVOL 10S that is the target VOL of the copying. The data transfer may be asynchronous remote copying, performed asynchronously with write processing for writing data to the PVOL 10P. The data to be transferred may be JNL. Each of the n pieces of compressed data may be compressed JNL data (data obtained by compressing JNL data that is a duplicate of the data written to the PVOL 10P). The meta-part is metadata corresponding to each of the n pieces of JNL data, and may include information indicating the compression scheme used in compressing the JNL data. When the result of the compression/decompression determination is false, the selected offload instance may be an offload instance that supports the compression scheme indicated by the meta-part. As a result, even if the primary storage 110P compresses the data to be transferred using a compression scheme not supported by the secondary storage 110S and transfers the compressed data, the secondary storage 110S can decompress the data part of the JNL using the selected offload instance 150. Furthermore, the JNL transferred via the asynchronous remote copying generally has a meta-part including metadata (e.g., JNCB) corresponding to each piece of JNL data, and the meta-part can be used to inform the secondary storage 110S of the compression scheme used in the primary storage 110P. In addition, if the first storage is a storage system not in the cloud 102 (in a configuration in which the remote copying is remote copying in a hybrid environment (remote copying between different types of environments)), the physical distance between the storages becomes extended, and it takes a long time to perform remote copying. Therefore, if synchronous remote copying, which makes a copy synchronously with the write processing, is used (which requires the remote copying to complete before the write processing completes), the time required to complete the write processing becomes extended. Therefore, the remote copying is preferably asynchronous remote copying.

When the asynchronous remote copying is the initial copying (copying of the entire data in the PVOL 10P to the SVOL 10S), the primary storage 110P may compress the JNL data to be transferred with a compression scheme having the highest compression ratio, among a plurality of compression schemes supported by the primary storage 110P. In this manner, the time required for the initial copying can be reduced, advantageously.

By contrast, when the asynchronous remote copying is the regular copying (in which data written to the PVOL 10P after the initial copying is copied to the SVOL 10S), the primary storage 110P may compress the JNL data to be transferred using a common compression scheme shared between the primary storage 110P and the secondary storage 110S, among the plurality of compression schemes supported by the primary storage 110P. The amount of inflow data to the PVOL 10P (the amount of data written to the PVOL 10P per unit time) is often determined on the basis of the communication bandwidth (network bandwidth) used in the transfer from the primary storage 110P to the secondary storage 110S, and thus, it is less likely for the regular copying to take up the communication bandwidth as much as the initial copying does. Therefore, in the regular copying, the primary storage 110P uses a common compression scheme to compress the JNL data to be transferred, so that the overhead accrued in offloading the decompression to the offload instance 150 can be reduced, to achieve a time reduction, advantageously. Note that, in the embodiment described above, the JVOL 10J is provided in each of the primary storage 110P and the secondary storage 110S, and JNL is accumulated in the JVOL 10J, but the JVOL 10J may be omitted in one or both of the primary storage 110P and the secondary storage 110S. In such a configuration, the JNL may be temporarily stored in the memory, and the compressed JNL data may be acquired from the memory.

When the asynchronous remote copying is the regular copying, the primary storage 110P may determine whether the accumulation ratio of the JNL data (the ratio of the total amount of the JNL data stored in the storage area for the JNL data (e.g., the JNL data area 602), with respect to the capacity of the storage area) is equal to or lower than a threshold. If the accumulation ratio is equal to or lower than the threshold, the primary storage 110P may use a first compression scheme to compress the JNL data to be transferred, among the plurality of compression schemes supported by the primary storage 110P. By contrast, if the accumulation ratio is higher than the threshold, the primary storage 110P may to use a second compression scheme having a higher compression ratio than the first compression scheme to compress the JNL data to be transferred, among the plurality of compression schemes. During the regular copying, the load of the sender of a write request (e.g., the host 51 or the application) may temporarily increase, and as a result, the amount of inflow to the PVOL 10P may increase. In this case, a transfer delay may occur. Therefore, the primary storage 110P may switch the compression scheme to be used, depending on the accumulation ratio. In this manner, the time required for regular copying can be reduced, advantageously.

When the result of the compression/decompression determination is false, the selected offload instance 150 may be an offload instance 150 supporting a common compression scheme that is shared between the primary storage 110P and the secondary storage 110S, in addition to the compression scheme indicated by the meta-part. The secondary storage 110S may receive data decompressed using the compression scheme indicated by the meta-part and then compressed again using the common compression scheme, from the selected offload instance 150, and store the compressed data in the SVOL 10S. In this manner, it is possible to store compressed data in the SVOL 10S with a less load on the secondary storage 110S. Because the compressed data is stored in the SVOL 10S, the consumption of the capacity of the SVOL 10S can be reduced. The secondary storage 110S may receive the decompressed data from the selected offload instance 150, compress the decompressed data with a common compression scheme, and store the compressed data in the SVOL 10S.

The data to be transferred may be an object 2372 transferred from the first storage to the second storage via the object storage 2350 in the cloud 102 (or another cloud environment that is different from the cloud 102). The first storage may obtain a snapshot VOL 10Y (snapshot) of the backup source VOL 10X. For each snapshot VOL 10Y of the backup source VOL 10X, the first storage may compress one or more data blocks, using a compression scheme supported by the first storage, and make a backup copy of one or more objects 2372 including the one or more compressed data blocks in the object storage 2350. The second storage may acquire one or more objects 2372 corresponding to a snapshot VOL 2370 to be restored, from the object storage 2350, based on the catalog information 2371 that is mapped to the snapshot VOL 2370 to be restored, the catalog information 2371 being information containing information of the location where each of the one or more objects 2372 is stored. For each of the acquired one or more objects 2372, the second storage may restore n data blocks obtained by decompressing the n compressed data blocks using the compression scheme indicated in the meta-part of the object 2372. (In the restoration, too, the second storage may make the compression/decompression determination described above, and if the determination result is false, cause the selected offload instance 150 to perform the decompression.) When the second storage is a storage other than an object storage (e.g., a block storage), a higher cost may be accrued in relation to the data storage in the second storage, than that in the object storage 2350. Therefore, by making a backup data in the object storage 2350 and restoring necessary data from the backup data in the object storage 2350 onto the second storage, the cost accrued in relation to the data storage can be reduced, advantageously.

The second storage may activate one or more offload instances 150 before performing data transfer (e.g., S1407), and inactivate the offload instance 150 having been activated after the data transfer is completed (e.g., S2107). As a result, it is possible to avoid unnecessary resource consumption (e.g., consumptions of physical resources (such as memory and CPU) of the cloud 102) resultant of keeping the offload instances 150 active for an unnecessarily long time. Note that a typical example of the “data transfer” referred to in this paragraph is initial copying, but may also be data transfer other than the initial copying, e.g., the regular copying, or backup copying of the snapshot VOL 10Y to the object storage 2350.

The second storage may also change the number of the active instances 150, on the basis of the processor loads of one or more active instances 150, each of which is an active offload instances among the one or more offload instances 150 (e.g., S2101 to S2105). In this manner, it is possible to adjust the number of active instances 150 dynamically during the data transfer, depending on the throughput required. Specifically, it is possible to optimize the processing speed and resource consumption. Note that the second storage may determine the active instance 150 to be added or removed, based on the information indicating, for each of one or more offload instances 150, the amount of resource on which the offload instance 150 is based (e.g., the information 1103 to 1105 in the offload instance management table 1100). In this manner, the processing speed and resource consumption can be further optimized, advantageously.

The data to be transferred may be data transferred from the second storage to the first storage. With this, the compression using a compression scheme supported by the first storage but not by the second storage can be offloaded to the selected offload instance 150 (an offload instance 150 supporting the compression scheme supported by the first storage), for the data transfer (e.g., copying data) from the second storage (cloud storage) to the first storage (e.g., on-premises storage). Furthermore, the egress cost can be reduced, advantageously.

As an offload instance 150 provided to the cloud 102, an offload instance 150 supporting a function other than a compression scheme may be used, instead of or in addition to the offload instance 150 supporting a compression scheme. The “function other than a compression scheme” may be an encryption scheme that is an encryption or decryption scheme (e.g., an algorithm or a key), or may be a function for calculating a warranty code. It is also possible to use an offload instance 150 to temporarily complement functions for data transfers between storages having no functional compatibilities. The offload instance 150 may support a function (e.g., an encryption scheme) other than a compression scheme, instead of or in addition to a compression scheme.

From the viewpoint of a storage system (storage), the following expression is also possible, for example.

In a storage system including a controller, when data is to be stored in or transferred to the storage system, the controller may cause a selected offload instance to compress or to decompress the data to be stored in or to be transferred to the storage system, the selected offload instance being one or more offload instances that support a specific compression scheme and to which a compression or decompression load is to be offloaded.

The storage system may be a storage system in a cloud environment, and the controller may perform data transfer of data to be transferred, with another storage system. In the data transfer, when a compression scheme used in the compression or decompression of the data to be transferred is not a compression scheme locally supported by the storage system, the controller may cause the selected offload instance to execute compression or decompression of the data to be transferred.

The data to be transferred may be data including a meta-part and a data part, and the data part may be n pieces of compressed data (where n is an integer equal to or more than one), and each of the n pieces compressed data may be data obtained by compressing the data to be transferred. The meta-part may include information indicating the compression scheme used in compressing the data to be transferred. The controller having received the data to be transferred may identify the compression scheme required to decompress the n pieces of compressed data of the data to be transferred, from the meta-part of the data to be transferred, and store the data resultant of decompressing each of the n pieces of compressed data, using the identified compression scheme. The data to be transferred may be data transferred from the other storage system to the storage system. The offload instance may decompress the compressed data to be transferred.

The controller of the storage system may transfer data to the other storage system, and the offload instance may decompress the data to be transferred having been compressed.

The other storage system may not support the specific compression scheme, and the storage system and the other storage system may compress or decompress the data to be transferred using respective offload instances.

The storage system may be a storage system in a cloud environment, and, when data is to be stored or transferred in response to a data input/output request from a host, the controller may cause the selected offload instance to compress or to decompress the data being stored.

The storage system may be a storage system in a cloud environment, and the controller may cause the selected offload instance to compress or to decompress data being stored and to restore the data being stored, asynchronously with storing or transferring of the data.

The other storage system may include a primary volume that is a source volume of copying. The storage system may include a secondary volume that is a target volume of the copying. The data transfer may be asynchronous remote copying that is performed asynchronously with write processing for writing data to the primary volume. The data to be transferred may be a journal. Each of the n pieces of compressed data is compressed journal data that is data obtained by compressing journal data, as a duplicate of data being written to the primary volume. The meta-part may be metadata corresponding to each one of n pieces of journal data, and may include information indicating a compression scheme used in compressing the journal data. When the result of the compression/decompression determination is false, the selected offload instance may be an offload instance that supports the compression scheme indicated by the meta-part.

When the asynchronous remote copying is the initial copying, the other storage system may compress the journal data to be transferred, using a compression scheme having the highest compression ratio, among the plurality of compression schemes supported by the other storage systems. The initial copying may be copying of the entire data in the primary volume, to the secondary volume.

When the asynchronous remote copying is the regular copying, the other storage system may compress the journal data to be transferred, using a common compression scheme shared between the other storage system and the storage system, among a plurality of compression schemes supported by the storage system. The regular copying may be copying of data written to the primary volume subsequently to the initial copying, to the secondary volume. The initial copying may be copying of the entire data in the primary volume, to the secondary volume.

When the asynchronous remote copying is the regular copying, the other storage system may determine whether an accumulation ratio of the journal data is equal to or less than a threshold, and when the accumulation ratio is equal to or lower than the threshold, the other storage system may compress the journal data to be transferred, using a first compression scheme, among a plurality of compression schemes supported by the other storage system. When the accumulation ratio is higher than the threshold, the other storage system may compress the journal data to be transferred, using a second compression scheme having a higher compression ratio than the first compression scheme, among the plurality of compression schemes. The regular copying may be copying of data written to the primary volume subsequently to the initial copying, to the secondary volume. The initial copying may be copying of the entire data in the primary volume, to the secondary volume. The accumulation ratio may be a ratio of a total amount of the journal data stored in a storage area for storing journal data, with respect to a capacity of the storage area.

When the result of the compression/decompression determination is false, the selected offload instance may be an offload instance supporting a common compression scheme that is shared between the other storage system and the storage system, in addition to a compression scheme indicated by the meta-part. The controller of the storage system may receive, from the selected offload instance, data decompressed using the compression scheme indicated by the meta-part and compressed using the common compression scheme, and store the compressed data in the secondary volume.

The data to be transferred may be an object transferred from another storage system to the second storage via an object storage in the cloud environment. Another storage system may obtain a snapshot of the backup source volume, compress one or more data blocks for each of the snapshots of the backup source volume, using a compression scheme supported by the first storage, and make a backup of one or more objects including one or more compressed data blocks to the object storage. The controller of the storage system may acquire one or more objects mapped to a snapshot to be restored, from the object storage, based on the catalog information that is mapped to the snapshot to be restored, the catalog information being information containing information of the location where each of the one or more objects is stored. For each of the acquired one or more objects, the controller may restore n data blocks obtained by decompressing n compressed data blocks using the compression scheme identified from the meta-part of the object.

The controller of the storage system may activate one or more offload instances before performing data transfer with another storage system, and inactivate the active offload instance after the completion of the data transfer.

The controller of the storage system may change a number of active instances based on a processor load of one or more active instances, each of which is an active offload instance among the one or more offload instances.

The controller of the storage system may determine the active instance to be added or removed, based on the information indicating, for each of one or more offload instances, the amount of resource on which the offload instance is based.

What is claimed is:

1. A storage system comprising a controller,
wherein, when data is to be stored in or transferred to the storage system,
the controller causes a selected offload instance to compress or to decompress the data to be stored in or to be transferred to the storage system, the selected offload instance being one or more offload instances that support a specific compression scheme and to which a compression or decompression load is to be offloaded.

2. The storage system according to claim 1, wherein
the storage system is a storage system in a cloud environment, and
the controller performs data transfer of data to be transferred, with another storage system, and
in the data transfer,
when a compression scheme used to compress or decompress the data to be transferred is not a compression scheme locally supported by the storage system, the controller causes the selected offload instance to execute compression or decompression of the data to be transferred.

3. The storage system according to claim 2, wherein
the data to be transferred is data including a meta-part and a data part, and
the data part is n pieces of compressed data (where n is an integer equal to or more than one),
each of the n pieces of compressed data being data obtained by compressing the data to be transferred, and
the meta-part includes information indicating the compression scheme used in compressing the data to be transferred, and
the controller having received the data to be transferred is configured to:
identify the compression scheme required to decompress the n pieces of compressed data of the data to be transferred, from the meta-part of the data to be transferred, and
store the data resultant of decompressing each of the n pieces of compressed data, using the identified compression scheme.

4. The storage system according to claim 2, wherein
the data to be transferred is data transferred from the other storage system to the storage system, and
the offload instance decompresses the compressed data to be transferred.

5. The storage system according to claim 1, wherein
the controller of the storage system transfers data to the other storage system, and
the offload instance decompresses the data to be transferred having compressed.

6. The storage system according to claim 1, wherein
the other storage system does not support the specific compression scheme, and
the storage system and the other storage system compress or decompress the data to be transferred using respective offload instances.

7. The storage system according to claim 1, wherein
the storage system is a storage system in a cloud environment, and
when data is to be stored or transferred in response to a data input/output request from a host, the controller causes the selected offload instance to compress or to decompress data being stored.

8. The storage system according to claim 1, wherein
the storage system is a storage system in a cloud environment, and
the controller causes the selected offload instance to compress or to decompress data being stored, and to restore the data being stored, asynchronously with storing or transferring.

9. The storage system according to claim 3, wherein
the other storage system includes a primary volume as a source volume of copying,
the storage system includes a secondary volume as a target volume of the copying,
the data transfer is asynchronous remote copying that is performed asynchronously with write processing for writing data to the primary volume,
the data to be transferred is a journal,
each of the n pieces of compressed data is compressed journal data that is data obtained by compressing journal data, as a duplicate of data written to the primary volume,
the meta-part is metadata corresponding to each one of n pieces of journal data, and including information indicating a compression scheme used in compressing the journal data, and
the selected offload instance is an offload instance that supports the compression scheme indicated by the meta-part.

10. The storage system according to claim 9, wherein
when the asynchronous remote copying is regular copying, the other storage system compresses journal data to be transferred using a common compression scheme that is shared between the other storage system and the storage system, among a plurality of compression schemes supported by the storage system,
the regular copying is copying of data written to the primary volume subsequently to the initial copying, to the secondary volume, and
the initial copying is copying of entire data in the primary volume, to the secondary volume.

11. The storage system according to claim 9, wherein
when the asynchronous remote copying is regular copying,
the other storage system determines whether an accumulation ratio of the journal data is equal to or less than a threshold,
when the accumulation ratio is equal to or lower than the threshold, the other storage system compresses the journal data to be transferred, using a first compression scheme, among a plurality of compression schemes supported by the other storage system,
when the accumulation ratio is higher than the threshold, the other storage system compresses the journal data to be transferred, using a second compression scheme havinga compression ratio higher than a compression ratio of the first compression scheme, among the plurality of compression schemes,
the regular copying is copying of data written to the primary volume subsequently to the initial copying, to the secondary volume,
the initial copying is copying of entire data in the primary volume, to the secondary volume, and
the accumulation ratio is a ratio of a total amount of journal data stored in a storage area for storing the journal data, with respect to a capacity of the storage area.

12. The storage system according to claim 9, wherein
when the result of the compression/decompression determination is false,
the selected offload instance is an offload instance supporting a common compression scheme that is shared between the other storage system and the storage system, in addition to a compression scheme indicated by the meta-part, and
the controller receives, from the selected offload instance, data decompressed using the compression scheme indicated by the meta-part and then compressed using the common compression scheme, and stores the compressed data in the secondary volume.

13. The storage system according to claim 1, wherein
the controller is configured to:
activate the one or more offload instances before performing data transfer with another storage system; and
inactivate the offload instance having been activated, after completion of the data transfer.

14. The storage system according to claim 1, wherein the controller changes a number of active instances based on a processor load of one or more active instances, each of which is an active offload instance among the one or more offload instances.

15. A storage control method comprising, when data is to be stored in or transferred to the storage system, causing the controller to cause a selected offload instance to compress or to decompress the data to be stored in or to be transferred to the storage system, the selected offload instance being one or more offload instances that support a specific compression scheme and to which a compression or decompression load is to be offloaded.
